(19) United States
(12) Patent Application Publication
(10) Pub. No.: US 2012/0218798 A1
(43) Pub. Date: Aug. 30, 2012

(54) POWER CONVERSION DEVICE

(75) Inventor: Ryuichi Shimada, Tokyo (JP)

(73) Assignee: MERSTech, Inc., Tokyo (JP)

(21) Appl. No.: 13/503,852

(22) PCT Filed: Oct. 8, 2010
(86) PCT No.: PCT/JP2010/067780

§ 371 Date: Apr. 27, 2012

(30) Foreign Application Priority Data
Oct. 28, 2009 (JP) 2009-247310

(51) Int. Cl. H02M 7/06

(52) U.S. Cl. 363/126

(57) ABSTRACT

A power conversion device (1) comprises an inductor (L) serried-connected to an alternating-current power source (20) and a load (30), a full-bridge MERS (100) parallel-connected to the load (30), a control circuit (110), a current direction switching part (200) serried-connected between the inductor (L) and load (30), and an ammeter (300). The control circuit (110) feeds back the current detected by the ammeter (300), repeatedly turns on/off either a pair of reverse conductive semiconductor switches (SW2, SW3) or a pair of reverse conductive semiconductor switches (SW1, SW4) constituting the full-bridge MERS (100), which corresponds to the positive/negative voltage output from the alternating-current source (20), and keeps the other pair being off.

### TECHNICAL FIELD

The present invention relates to a power conversion device.

### BACKGROUND ART

Generally, a booster circuit is used to boost an input voltage and output it. For example, some booster circuits convert alternating-current power output from an alternating-current power generator to a direct-current power by means of a rectifier circuit such as a diode bridge, boost the voltage by means of a booster chopper circuit, and supply the voltage to a load.

However, for using a booster chopper circuit, for example, to boost the output of an alternating-current power generator, rectification by a diode bridge is essential. In addition, if such a booster chopper circuit is used to boost the output of an alternating-current power generator, a current with a lagging power factor flows through the alternating-current power generator and the armature reaction lowers the output voltage. Then, the power factor of the alternating-current power generator is lowered and, therefore, the alternating-current power generator cannot exert full performance.

In order to improve the power factor, power factor correction, so-called PFC, converter schemes utilizing the switching mode rectifying technique are widely used. However, even if a PFC converter scheme is used, the output of an alternating-current power generator should once be rectified to a direct current. Therefore, various devices have been proposed.

For example, some PFC circuits are of the AC-operated bridgeless boost (BLB) type in which a reactor is connected to an alternating-current power source to improve the power factor instead of using a transducer for boosting. A BLB PFC circuit has a smaller number of parts and low loss compared with a conventional PFC circuit comprising a diode bridge.

However, use of a direct-current reactor makes a BLB PFC circuit large and heavy. Compared with an alternating-current reactor, a direct-current reactor is large in size because of influence of direct-current biased magnetization. Furthermore, leakage reactance from insulated transducers and internal inductance of the power generator cannot be utilized. Furthermore, the switching operation for PFC control while a voltage is applied to a load is hard switching.

Patent Literature 1 discloses an AC/DC converter that is capable of boosting, uses soft switching in the switching operation, and is capable of adjusting the power factor of the output of an alternating-current power source to nearly 1.

This AC/DC converter is constructed by series-connecting a magnetic energy recovery switch consisting of four reverse conductive semiconductor switches and a capacitor, a reactor, and an alternating-current power source, in which the reverse conductive semiconductor switches are turned on/off in sync with an alternating-current voltage so that the capacitor and reactor resonate. The resonance voltage is retrieved by a diode rectifier circuit so that a direct-current voltage higher than the input alternating-current voltage is applied to a load. Furthermore, the current flowing through the alternating-current power source has a reduced level of higher harmonic waves and the power factor of the alternating-current power source is increased.

### PRIOR ART LITERATURE

### Patent Literature

Patent Literature 1: Unexamined Japanese Patent Application KOKAI Publication No. 2007-174723.

### Problems to be Solved by the Invention

However, with the AC/DC converter described in the Patent Literature 1, the current flowing through the alternating-current power source has the waveform distorted and a desired sinusoidal wave cannot be obtained from the alternating-current power source. Furthermore, the AC/DC converter described in the Patent Literature 1 can boost a voltage output from an alternating-current power source and apply a direct-current voltage to a load, but cannot apply an alternating-current voltage to a load.

The present invention is invented in view of the above problems and an exemplary object of the present invention is to provide a compact and low loss power conversion device capable of obtaining a desired waveform from an alternating-current power source, boosting or lowering the alternating-current voltage, and adjusting the power supplied to a load.

Furthermore, another exemplary object of the present invention is to provide a power conversion device capable of PFC control by means of soft switching.

### DISCLOSURE OF INVENTION

### Means for Solving the Problems

In order to achieve the above object, the power conversion device according to a first exemplary aspect of the present invention comprises:

an inductor having one end connected to one end of an alternating-current power source having the other end connected to a reference potential point;

a current direction switching means comprising an input terminal connected to the other end of the inductor and an output terminal connected to one end of a load, and switching the current conduction direction by conducting the current flowing from the input terminal to the output terminal and cutting off the current flowing from the output terminal to the input terminal when the output voltage of the alternating-current power source is positive, and conducting the current flowing from the output terminal to the input terminal and cutting off the current flowing from the input terminal to the output terminal when the output voltage of the alternating-current power source is negative;

a magnetic energy recovery switch comprising first and second alternating-current terminals, first and second direct-current terminals, first through fourth diodes, first through fourth self arc-extinguishing elements, and a capacitor, in which the anode of the first diode and the cathode of the second diode are connected to the first alternating-current terminal, the cathodes of the first and third diodes and one electrode of the capacitor are connected to the first direct-current terminal, the anodes of the second and fourth diodes and the other electrode of the capacitor are connected to the second direct-current terminal, the anode of the third diode and the cathode of the fourth diode are connected to the second alternating-current terminal, the first, second, third, and fourth self arc-extinguishing elements are parallel-connected to the first, second, third, and fourth diodes, respectively, the input terminal is connected to the first alternating-current terminal, and the other end of the load and the reference potential point are connected to the second alternating-current terminal; and

a control means controlling the self arc-extinguishing elements to turn on/off them,

wherein the control means repeatedly switches on/off either a pair of the second and third self-extinguishing elements or a pair of the first and fourth self-extinguishing elements, which corresponds to the positive/negative voltage output from the alternating-current power, at a frequency equal to or higher than the frequency of the output voltage of the alternating-current power source, and keeps the other pair being off.

In order to achieve the above object, the power conversion device according to a second exemplary aspect of the present invention comprises:

an inductor having one end connected to one end of an alternating-current power source having the other end connected to a reference potential point;

a current direction switching means comprising first and second input terminals and first and second output terminals, in which a series circuit of the alternating-current power source and inductor is connected between the first and second input terminals and a load is connected between the first and second output terminals for rectifying an alternating current entered from the first and second input terminals to a direct current and outputting it from between the first and second output terminals;

a magnetic energy recovery switch comprising first and second alternating-current terminals, first and second direct-current terminals, first through fourth diodes, first through fourth self arc-extinguishing elements, and a capacitor, in which the anode of the first diode and the cathode of the second diode are connected to the first alternating-current terminal, the cathodes of the first and third diodes and one electrode of the capacitor are connected to the first direct-current terminal, the anodes of the second and fourth diodes and the other electrode of the capacitor are connected to the second direct-current terminal, the anode of the third diode and the cathode of the fourth diode are connected to the second alternating-current terminal, the first, second, third, and fourth self arc-extinguishing elements are parallel-connected to the first, second, third, and fourth diodes, respectively, the first input terminal is connected to the first alternating-current terminal, and the second input terminal is connected to the second alternating-current terminal; and

a control means controlling the self arc-extinguishing elements to turn on/off them,

wherein the control means repeatedly switches on/off either a pair of the second and third self-extinguishing elements or a pair of the first and fourth self-extinguishing elements, which corresponds to the positive/negative voltage output from the alternating-current power, at a frequency equal to or higher than the frequency of the output voltage of the alternating-current power source, and keeps the other pair being off.

In order to achieve the above object, the power conversion device according to a third exemplary aspect of the present invention comprises:

first, second, and third inductors having one end connected to each phase of a three-phase alternating-current power source;

a current direction switching means comprising first, second, and third input terminals and first, second, and third output terminals, in which the other end of the first inductor is connected to the first input terminal, the other end of the second inductor is connected to the second input terminal, and the other end of the third inductor is connected to the third input terminal, and a load is connected between the first and second output terminals for rectifying a three-phase alternating current entered from the first, second, and third input terminals to a direct current and outputting it from between the first and second output terminals;

a magnetic energy recovery switch comprising first, second, and third alternating-current terminals, first and second direct-current terminals, first through sixth diodes, first through sixth self arc-extinguishing elements, and a capacitor, in which the anode of the first diode and the cathode of the second diode are connected to the first alternating-current terminal, the anode of the third diode and the cathode of the fourth diode are connected to the second alternating-current terminal, the anode of the fifth diode and the cathode of the sixth diode are connected to the third alternating-current terminal, the cathodes of the first, third, and fifth diodes and one electrode of the capacitor are connected to the first direct-current terminal, the anodes of the second, fourth, and sixth diodes and the other electrode of the capacitor are connected to the second direct-current terminal, the first, second, third, fourth, fifth, and sixth self arc-extinguishing elements are parallel-connected to the first, second, third, fourth, fifth, and sixth diodes, respectively, the first input terminal is connected to the first alternating-current terminal, the second input terminal is connected to the second alternating-current terminal, and the third input terminal is connected to the third alternating-current terminal; and

a control means controlling the self arc-extinguishing elements to turn on/off them,

wherein the control means repeatedly switches the first self arc-distinguishing element at a frequency equal to or higher than the frequency of the output voltage of the alternating-current power source and keeps the second self arc-distinguishing element being off when the first phase output of the three-phase alternating-current power source is positive, and repeatedly switches on/off the second self arc-distinguishing element at a frequency equal to or higher than the frequency of the output voltage of the alternating-current power source and keeps the first self arc-distinguishing element being off when the first phase output is negative, repeatedly switches the third self arc-distinguishing element at a frequency equal to or higher than the frequency of the output voltage of the alternating-current power source and keeps the fourth self arc-distinguishing element being off when the second phase output is positive, and repeatedly switches on/off the fourth self arc-distinguishing element at a frequency equal to or higher than the frequency of the output voltage of the alternating-current power source and keeps the third self arc-distinguishing element being off when the second phase output is negative, and repeatedly switches the fifth self arc-distinguishing element at a frequency equal to or higher than the frequency of the output voltage of the alternating-current power source and keeps the sixth self arc-distinguishing element being off when the third phase output is positive, and repeatedly switches on/off the sixth self arc-distinguishing element at a frequency equal to or higher than the frequency of the output voltage of the alternating-current power source and keeps the fifth self arc-distinguishing element being off when the third phase output is negative.

### Effect of the Invention

The present invention can obtain a desired waveform from an alternating-current power source, boost or lower the alternating-current voltage, and adjust the power supplied to a load with small loss.

Furthermore, the PFC control may be performed by means of soft switching.

### BRIEF DESCRIPTION OF DRAWINGS

FIG. 1 is a circuit diagram showing the configuration of the power conversion device according to Embodiment 1 of the present invention;

FIG. 2A is an illustration showing the discharge P mode that is an operation mode of the power conversion device in FIG. 1;

FIG. 2B is an illustration showing the parallel P mode that is an operation mode of the power conversion device in FIG. 1;

FIG. 2C is an illustration showing the charge P mode that is an operation mode of the power conversion device in FIG. 1;

FIG. 3A is an illustration showing the discharge N mode that is an operation mode of the power conversion device in FIG. 1;

FIG. 3B is an illustration showing the parallel N mode that is an operation mode of the power conversion device in FIG. 1;

FIG. 3C is an illustration showing the charge N mode that is an operation mode of the power conversion device in FIG. 1;

FIG. 4A is a chart showing an exemplary relationship between the output of a power source and the voltage applied to a load in the power conversion device shown in FIG. 1;

FIG. 4B is a chart showing an exemplary relationship between the output of a power source and the voltage applied to a load in the power conversion device shown in FIG. 1;

FIG. 5 is a chart showing the relationship between the current flowing through an alternating-current power source and a target current in the power conversion device shown in FIG. 1;

FIG. 6 is a chart showing the relationship between the current flowing through an alternating-current power source and a target current in the power conversion device shown in FIG. 1;

FIG. 7 is a circuit diagram showing the configuration of the power conversion device according to Embodiment 2 of the present invention;

FIG. 8A is a chart showing the current flowing through the alternating-current power source of the power conversion device shown in FIG. 7;

FIG. 8B is a chart showing the voltage applied to a load by the power conversion device shown in FIG. 7 and the voltage of the capacitor;

FIG. 8C is a chart showing a gate signal of the power conversion device shown in FIG. 7;

FIG. 8D is a chart showing a gate signal of the power conversion device shown in FIG. 7;

FIG. 9 is a chart showing change in the current and voltage of a reverse conductive semiconductor switch in association with the switching in the power conversion device shown in FIG. 7;

FIG. 10 is a circuit diagram showing the configuration of the power conversion device according to Embodiment 3 of the present invention;

FIG. 11A is a chart showing the current flowing through the alternating-current power source of the power conversion device shown in FIG. 10;

FIG. 11B is a chart showing the voltage applied to a load by the power conversion device shown in FIG. 10, the voltage of the capacitor, and the voltage output by the alternating-current power source;

FIG. 11C is a chart showing the power consumed by a load with the power conversion device shown in FIG. 10;

FIG. 12 is a circuit diagram showing the configuration of the power conversion device according to Embodiment 4 of the present invention;

FIG. 13 is a circuit diagram showing the configuration of the power conversion device according to Embodiment 5 of the present invention; and

FIG. 14 is a diagram showing an application of the power conversion device shown in FIGS. 1, 7, 12, and 13 to a direct-current power source.

### BEST MODE FOR CARRYING OUT THE INVENTION

The power conversion device according to embodiments of the present invention will be described hereafter with reference to the drawings.

### Embodiment 1

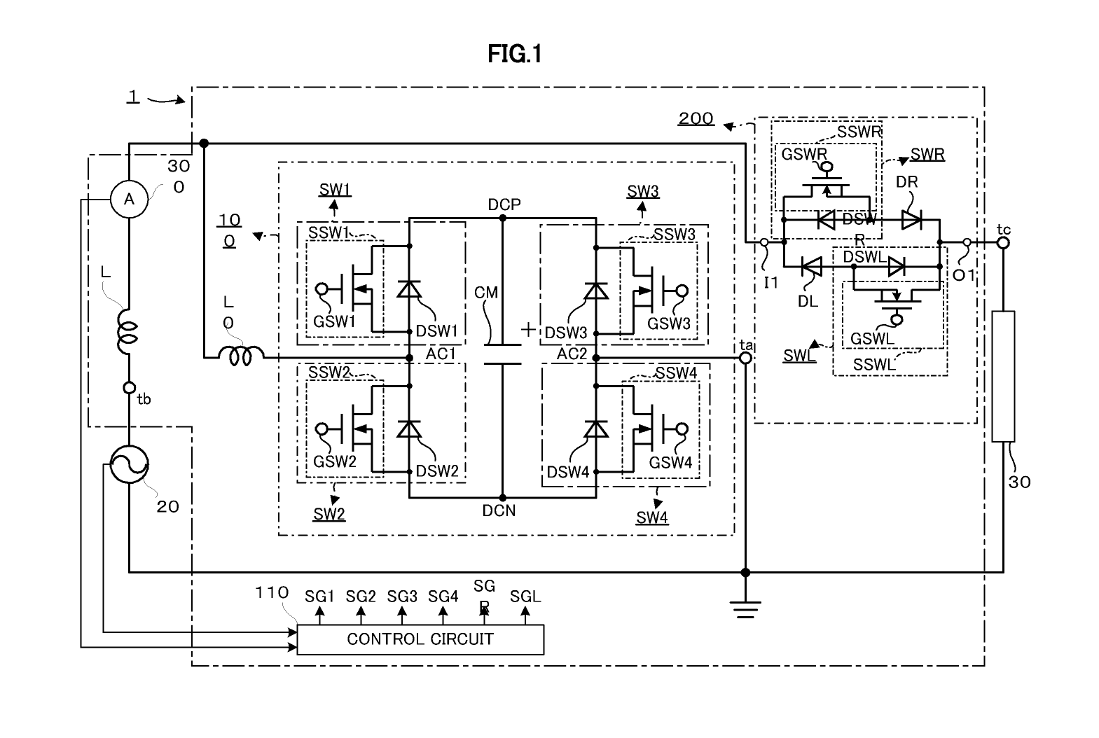

A power conversion device 1 according to this embodiment is a device chopping a full-bridge MERS 100 to increase the power to be supplied from an alternating-current power source 20 to a load 30, and controlling the waveform and improving the power factor of the current flowing through the alternating-current power source 20. The power conversion device 1 comprises, as shown in FIG. 1, inductors L and L0, a full-bridge MERS 100, a control circuit 110, a current direction switching part 200, an ammeter 300, and connection terminals ta, tb, and tc.

The full-bridge MERS 100 comprises four reverse conductive semiconductor switches SW1 to SW4, a capacitor CM, alternating-current terminals AC1 and AC2, and direct-current terminals DCP and DCN.

The reverse conductive semiconductor switches SW1 to SW4 of the full-bridge MERS 100 are each comprises a diode part DSW1, DSW2, DSW3, or DSW4, a switch part SSW1, SSW2, SSW3, or SSW4 parallel-connected to the diode part DSW1, DSW2, DSW3, or DSW4, and a gate part GSW1, GSW2, GSW3, or GSW4 provided to the switch part SSW1, SSW2, SSW3, or SSW4.

The current direction switching part 200 comprises an input terminal I1, an output terminal O1, reverse conductive semiconductor switches SWR and SWL, and diodes DR and DL.

The reverse conductive semiconductor switches SWR and SWL of the current direction switching part 200 are each comprises a diode part DSWR or DSWL, a switch part SSWR or SSWL parallel-connected to the diode part DSWR or DSWL, and a gate part GSWR or GSWL provided to the switch part SSWR or SSWL.

The alternating-current power source 20 is connected to the terminal tb at one end and connected to a grounded line connected to a reference potential point at the other end.

The load 30 is connected to the terminal tc at one end and connected to the grounded line at the other end.

The inductor L is connected to the terminal tb at one end and connected to the input terminal I1 of the current direction switching part 200 and one end of the inductor L0 at the other end.

The cathode of the diode part DSWR and the cathode of the diode DL are connected to the input terminal I1 of the current direction switching part 200.

The anode of the diode DR is connected to the anode of the diode part DSWR and the anode of the diode part DSWL is connected to the anode of the diode DL. The cathode of the diode DR and the cathode of the diode part DSWL are connected to the output terminal O1.

The output terminal O1 of the current direction switching part 200 is connected to the terminal tc.

The other end of the inductor L0 is connected to the alternating-current terminal AC1 of the full-bridge MERS 100. The alternating-current terminal AC2 of the full-bridge MERS 100 is connected to the connection terminal ta.

The terminal ta is connected to the grounded line.

The anode of the diode part DSW1 and the cathode of the diode part DSW2 are connected to the alternating-current terminal AC1 of the full-bridge MERS 100. The cathode of the diode part DSW1, cathode of the diode part DSW3, and positive electrode of the capacitor C1 are connected to the direct-current terminal DCP. The anode of the diode part DSW2, anode of the diode part DSW4, and negative electrode of the capacitor C1 are connected to the direct-current terminal DCN. The anode of the diode part DSW3 and cathode of the diode part DSW4 are connected to the alternating-current terminal AC2.

The ammeter 300 is series-connected to the inductor L so as to measure the current flowing through the inductor L and supplies the measured current value to the control circuit 110.

The control circuit 110 receives the voltage output by the alternating-current power source 20 and supplies it to the reverse conductive semiconductor switches SW1 to SW4, SWR, and SWL.

The inductor L has alternating-current reactance of, for example, 10 mH and functions using the alternating-current power source 20 as the current source.

The inductor L0 is a small coil of, for example, 100 μH and smoothes the rising edge of a current flowing through the full-bridge MERS 100.

The switch part SSWx (x=1, 2, 3, 4, R, and L) of the reverse conductive semiconductor switch SWx is turned on when an ON signal is supplied to the gate GSWx and turned off when an OFF signal is supplied.

When the switch part SSWx is turned on, the diode part DSWx is short-circuited and the reverse conductive semiconductor switch SWx is turned on.

When the switch part SSWx is turned off, the diode part DSWx functions and the reverse conductive semiconductor switch SWx is turned off.

The reverse conductive semiconductor switch SWx is, for example, an N-channel type silicon MOSFET (metal oxide semiconductor field effect transistor).

The full-bridge MERS 100 selectively conducts/cuts off the current flowing through the part between the alternating-current terminals AC1 and AC2 of the full-bridge MERS 100. The full-bridge MERS 100 is a switch for regenerating the magnetic energy accumulated as static energy. More specifically, the full-bridge MERS 100 accumulates the current flowing due to magnetic energy in the capacitor CM as static energy upon cutoff of the current and regenerates the accumulated magnetic energy in the direction in which the current flows upon subsequent conduction of the current.

When the reverse conductive semiconductor switches SW2 and Sw3 are on and the reverse conductive semiconductor switches SW1 and SW1 are off, the full-bridge MERS 100 conducts the current flowing from the alternating-current terminal AC1 to the alternating-current terminal AC2. The full-bridge MERS 100 cuts off the current flowing from the alternating-current terminal AC2 to the alternating-current terminal AC1.

Similarly, when the reverse conductive semiconductor switches SW1 and Sw4 are on and the reverse conductive semiconductor switches SW2 and SW3 are off, the full-bridge MERS 100 conducts the current flowing from the alternating-current terminal AC2 to the alternating-current terminal AC1. The full-bridge MERS 100 cuts off the current flowing from the alternating-current terminal AC1 to the alternating-current terminal AC2.

The current direction switching part 200 conducts the current flowing from the input terminal I1 to the output terminal O1 and cuts off the current flowing from the output terminal O1 to the input terminal I1 when the reverse conductive semiconductor switch SWR is on and the reverse conductive semiconductor switch SWL is off.

Similarly, the current direction switching part 200 conducts the current flowing from the output terminal O1 to the input terminal I1 and cuts off the current flowing from the input terminal I1 to the output terminal O1 when the reverse conductive semiconductor switch SWL is on and the reverse conductive semiconductor switch SWR is off.

The reverse conductive semiconductor switches SWR and SWL are turned on/off based on gate signals output from the control circuit 110. When the voltage output from the alternating-current power source 20 is positive, the current direction switching part 200 conducts the current flowing from the input terminal I1 to the output terminal O1 and cuts off the current flowing from the output terminal O1 to the input terminal I1. On the other hand, when the voltage output from the alternating-current power source 20 is negative, the current direction switching part 200 conducts the current flowing from the output terminal O1 to the input terminal I1 and cuts off the current flowing from the input terminal I1 to the output terminal O1.

The control circuit 110 outputs a gate signal SGx indicating ON or OFF to the gate GSWx of the reverse conductive semiconductor switch SWx. The reverse conductive semiconductor switch SWx is turned on/off based on whether the gate signal SGx is an ON or OFF signal. Either a pair of gate signals SG2 and SG3 or a pair of gate signals SG1 and SG4, which corresponds to the positive/negative voltage output from the alternating-current power source 20, is repeatedly switched between ON and OFF signals through PWM (pulse width modulation) of a predetermined frequency f. The duty ratio of ON and OFF signals is variable and the frequency f is, for example, 6 kHz. The gate signals SGR and SGL are switched to an ON signal or to an OFF signal in accordance with whether the voltage output from the alternating-current power source 20 is positive or negative.

The control circuit 110 switches the gate signals SG2 and SG3 between ON and OFF signals when the output voltage of the alternating-current power source 20 is positive. The control circuit 110 keeps the gate signal SGR always being an ON signal and the gate signals SG1, SG4, and SGL being an OFF signal. The control circuit 110 switches the gate signals SG1 and SG4 between ON and OFF signals when the output voltage of the alternating-current power source 20 is negative. The control circuit 110 keeps the gate signal SGL being an ON signal and the gate signals SG2, SG3, and SGR being an OFF signal.

With the above control, the boosted output voltage of the alternating-current power source 20 is applied to the load 30.

Furthermore, the control circuit 110 improves the power factor of the alternating-current power source 20 through PFC control. The control circuit 110 feeds back information obtained from the ammeter 300 with regard to the current flowing through the inductor L. Then, the control circuit 110 controls the duty ratio of the gate signals SG1 to SG4 through PWM so that the current flowing through the inductor L has a target waveform stored in the memory in advance. The target waveform is, for example, a sinusoidal wave having the same phase and cycle as the alternating-current voltage output from the alternating-current power source 20 and having a predetermined peak value.

As described above, the power conversion circuit 1 works as a transformer boosting the input alternating-current voltage and supplying it to the load 30.

The PFC control of the control circuit 110 enables the alternating-current power source 20 to output a constant power. Furthermore, since the control circuit 110 amplifies the current flowing through the alternating-current power source 20, the quantity of current flowing through the load 30 is increased. Consequently, the voltage applied to the load 30 is boosted.

The control circuit 110 is an electronic circuit comprises, for example, a comparator, a flip-flop and a timer.

The capacitance of the capacitor CM is adjusted so that the resonance frequency fr with the inductor L is higher than the frequency f of the gate signals output from the control circuit 110.

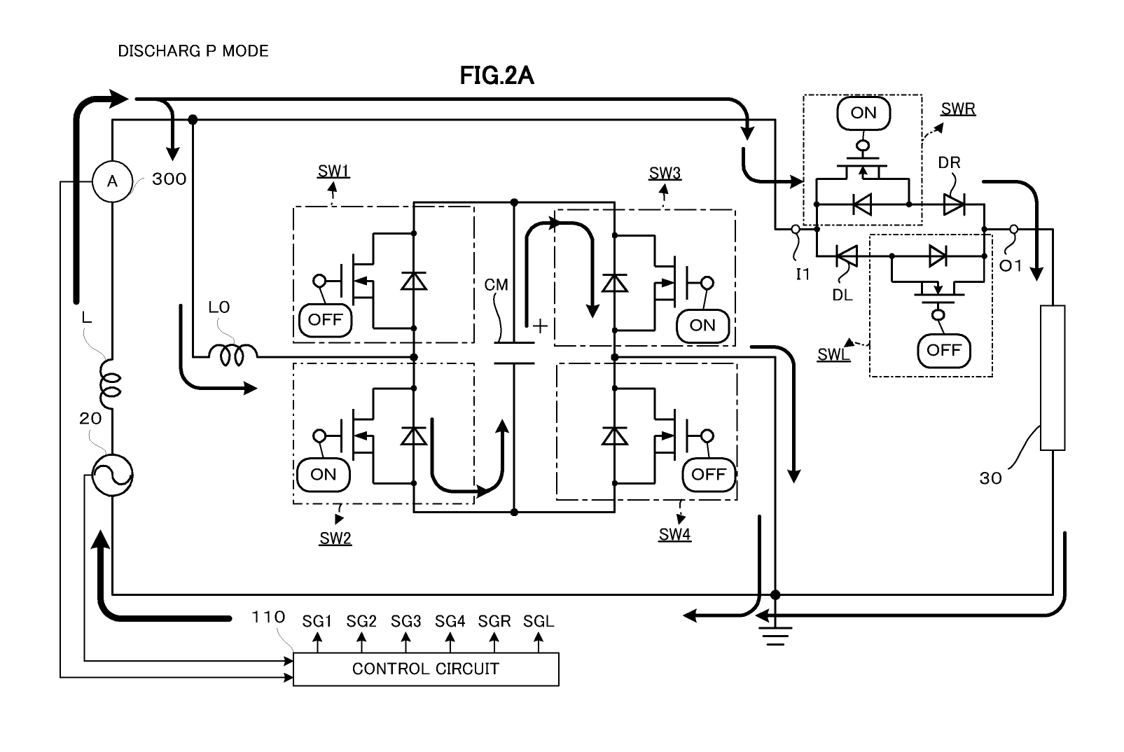

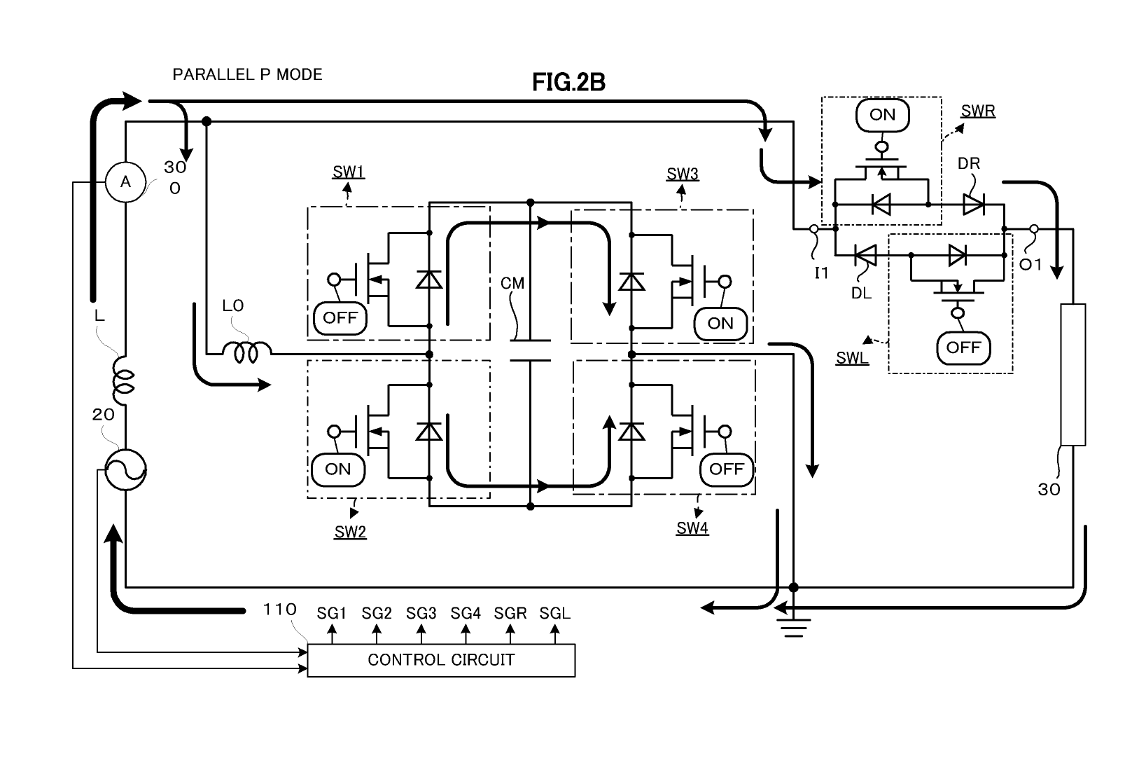

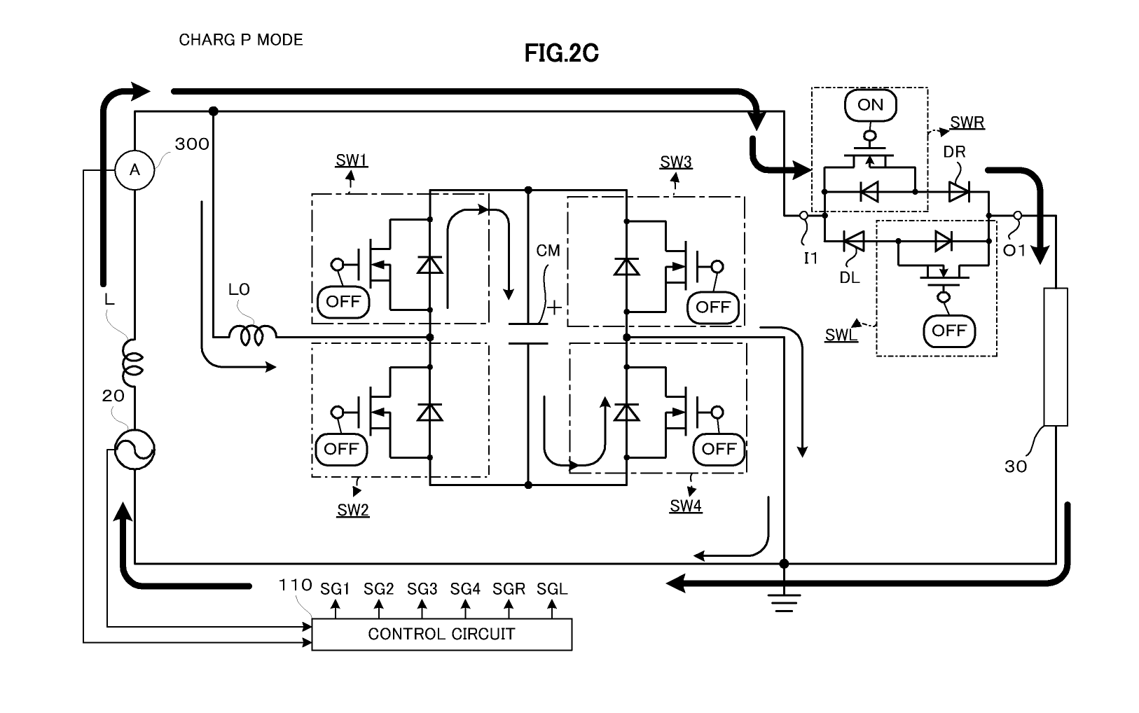

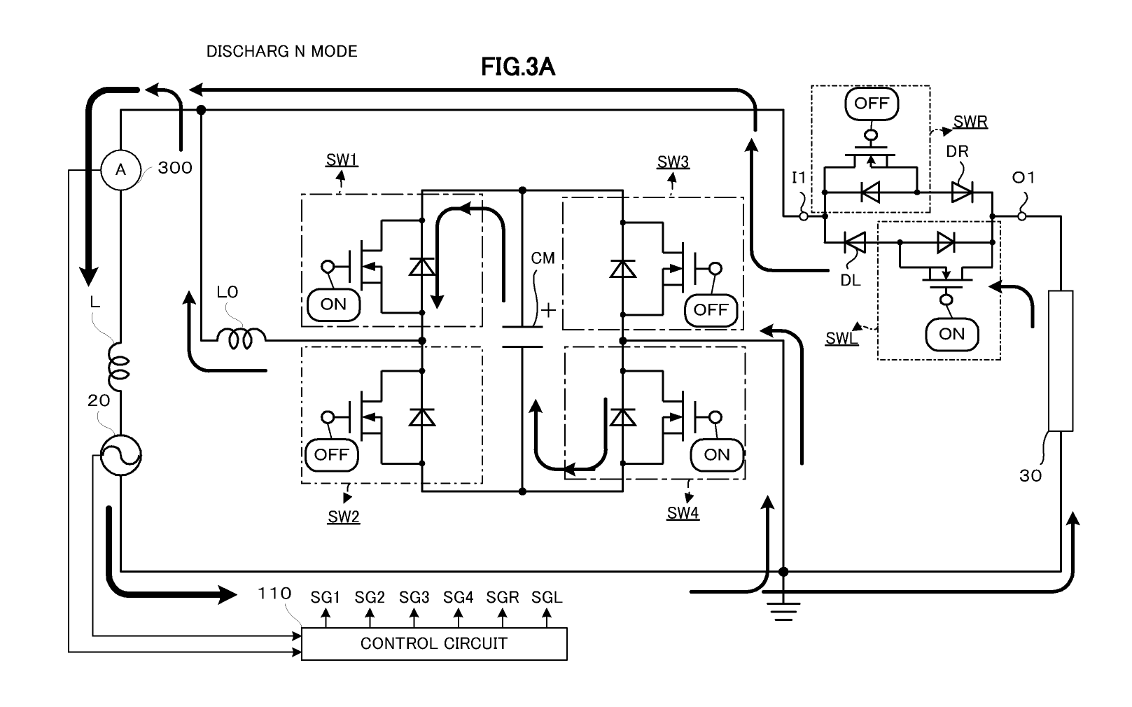

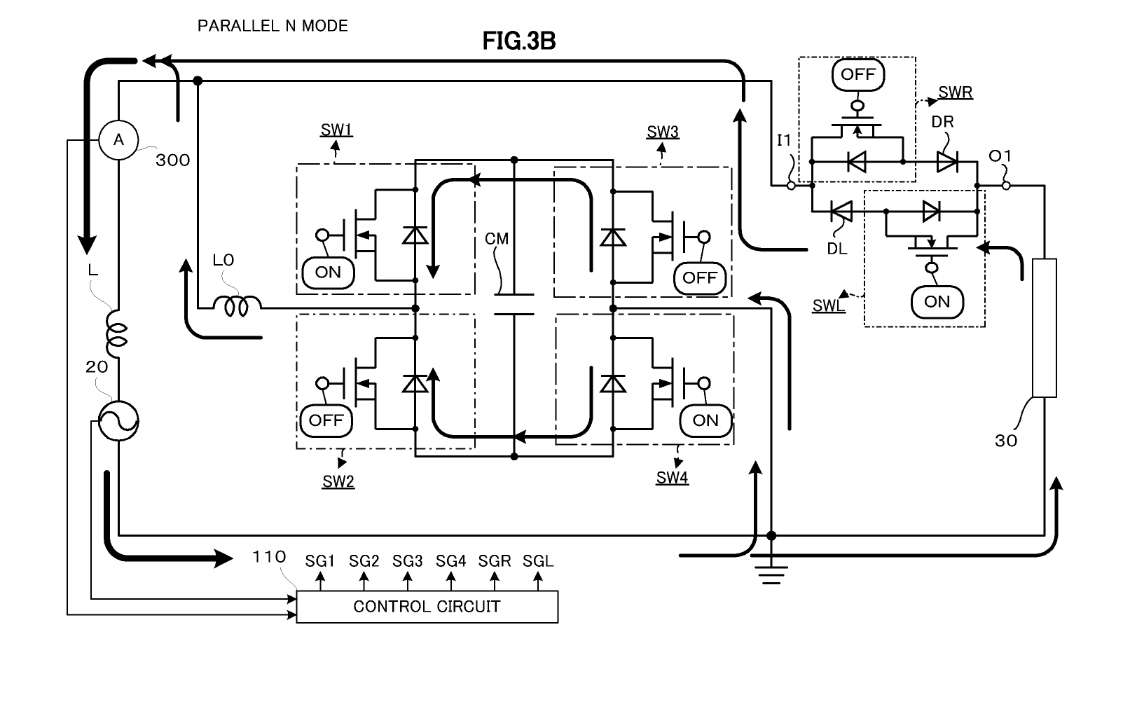

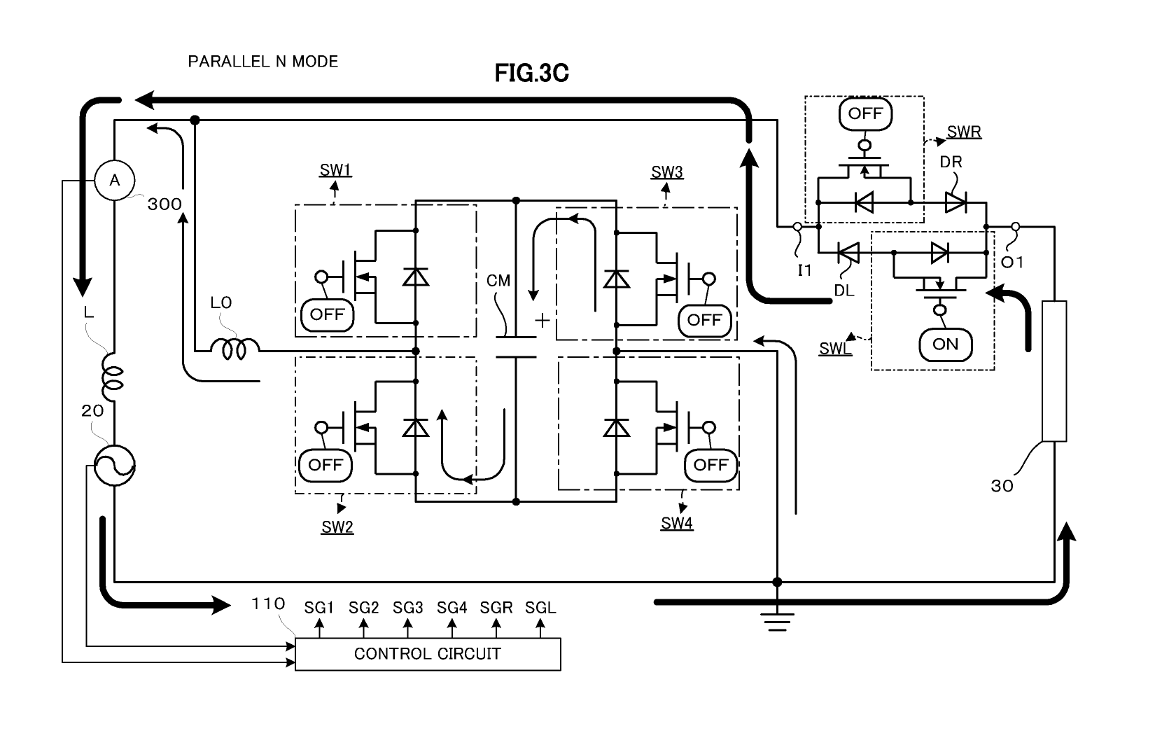

The power conversion device 1 having the above configuration adjusts the current flowing through the load 30 by repeatedly switching among a discharge P mode, parallel P mode, charge P mode, discharge N mode, parallel N mode, and charge N mode, described later, shown in FIGS. 2A to 2C and 3A to 3C.

In the following explanation of the operation modes, the arrows in the figures indicate that the current flowing in the direction of the arrow is positive and the current flowing in the opposite direction is negative.

Furthermore, in the following explanation, the time immediately before the voltage output from the alternating-current power source 20 switched from negative to positive is the start time, T0. It is assumed that the power conversion device 1 is in the charge N mode, described later, shown in FIG. 3C at the time T0. In the charge N mode, the reverse conductive semiconductor switches SW1 to SW4 and SWR are off and the reverse conductive semiconductor switch SWL is on. The capacitor CM has charge accumulated.

### (Discharge P Mode) (FIG. 2A)

At a time T1, the control circuit 110 switches the gate signals SG2, SG3, and SGR to ON signals and the gate signal SGL to an OFF signal, and keeps the gate signals SG1 and SG4 being OFF signals. Consequently, the reverse conductive semiconductor switches SW2, SW3, and SWR are turned on and the reverse conductive semiconductor switch SWL is turned off, whereby the current flows as shown in FIG. 2A. The reverse conductive semiconductor switches SW1 and SW4 remain off.

The current flowing through the inductor L and alternating-current power source 20 is divided into a current Iload flowing through the load 30 via the current direction switching part 200 and a current Imers flowing through the full-bridge MERS 100.

The current Imers passes through the inductor L0 and flows into the negative electrode of the capacitor CM via the ON reverse conductive semiconductor switch SW2. The capacitor CM discharges from the positive electrode, and the current flowing out from the positive electrode of the capacitor CM returns to the alternating-current power source 20 via the ON reverse conductive semiconductor switch SW3.

The current Iload passes through the ON reverse conductive semiconductor switch SWR, flows through the load 30 via the diode DR, and returns to the alternating-current power source 20.

The inductor L accumulates magnetic energy due to the currents load and Imers.

### (Parallel P Mode) (FIG. 2B)

At a time T2 when the discharge of the capacitor CM is completed and the potential difference between the ends of the capacitor CM becomes nearly zero, the current starts to flow as shown in FIG. 2B.

The current Imers passes through the inductor L0 and then takes two routes to return to the alternating-current power source 20: one route is through the OFF reverse conductive semiconductor switch SW1 and ON reverse conductive semiconductor switch SW3, and the other route is through the ON reverse conductive semiconductor switch SW2 and OFF reverse conductive semiconductor switch SW4.

The inductor L accumulates more magnetic energy or less magnetic energy as the currents Imers and Iload increase or decrease.

### (Charge P Mode) (FIG. 2C)

At a time T3 when the output of the ammeter 300 is fed back and the above parallel P mode has continued for a given time period, the control circuit 110 switches the gate signals SG2 and SG3 to OFF signals. The gate signal SGR is kept being an ON signal and the other gate signals are kept being OFF signals. Since the voltage between the ends of the capacitor CM is nearly zero, this switching operation is soft switching.

The reverse conductive semiconductor switches SW2 and SW3 are turned off and the current flows as shown in FIG. 2C.

The current flowing through the reverse conductive semiconductor switches SW2 and SW3 is cut off. Then, the current due to the magnetic energy accumulated in the inductor L0 and the like flows into the positive electrode of the capacitor CM via the OFF reverse conductive semiconductor switch SW1. The capacitor CM is charged and the current flowing out from the negative electrode of the capacitor CM returns to the alternating-current power source 20 via the OFF reverse conductive semiconductor switch SW4. After the magnetic energy is exhausted and the charge of the capacitor CM is completed, the current Imers is cut off.

Since the current Imers is cut off, the magnetic energy accumulated in the inductor L by the currents Imers and Iload causes a current to flow through the load 30. Consequently, the current load flowing through the load 30 is increased and the voltage of the load 30 is also increased.

The current flowing through the inductor L0 is gradually decreased as the magnetic energy is consumed. After the magnetic energy accumulated in the inductor L0 and line inductance is exhausted and the charge of the capacitor CM is completed, the current Imers is cut off.

### (Discharge P Mode) (FIG. 2A)

At a time T4 corresponding to the predetermined cycle of frequency f, the control circuit 110 switches the gate signals SG2 and SG3 to ON signals. The gate signal SGR is kept being an ON signal and the other gate signals are kept being OFF signals. Since the current Imers is cut off, the switching operation is soft switching.

The reverse conductive semiconductor switches SW2 and SW3 are turned on and the current resumes flowing as shown in FIG. 2A.

The control circuit 110 repeats the above operation along with controlling the duty ratio of the gate signals SG2 and SG3 so that the current flowing through the inductor L and detected by the ammeter 300 has a target waveform while the output voltage of the alternating-current power source 20 is positive.

### (Discharge N Mode) (FIG. 3A)

At a time T5 when the voltage output from the alternating-current power source 20 is switched from positive to negative and the capacitor CM retains charge, the control circuit 110 switches the gate signals SG1, SG4, and SGL to ON signals and the gate signals SG2, SG3, and SGR to OFF signals. Consequently, the reverse conductive semiconductor switches SW1, SW4, and SWL are turned on and the reverse conductive semiconductor switches SW2, SW3, and SWR are turned off, whereby the current flows as shown in FIG. 3A.

The current flowing from the alternating-current power source 20 is divided into a current load flowing through the current direction switching part 200 via the load 30 and a current Imers flowing through the full-bridge MERS 100.

The current Imers flows into the negative electrode of the capacitor CM via the ON reverse conductive semiconductor switch SW4. The capacitor CM discharges and the current flowing out from the positive electrode of the capacitor CM returns to the alternating-current power source 20 via the ON reverse conductive semiconductor switch SW1 and inductor L0.

The current Iload flows through the load 30 and returns to the alternating-current power source 20 via the ON reverse conductive semiconductor switch SWL and diode DL.

### (Parallel N Mode) (FIG. 3B)

At a time T6 when the discharge of the capacitor CM is completed and the potential difference between the ends of the capacitor CM becomes nearly zero, the current starts to flow as shown in FIG. 3B.

The current Imers takes two routes to return to the alternating-current power source 20 via the inductor L0: one route is through the OFF reverse conductive semiconductor switch SW3 and ON reverse conductive semiconductor switch SW1 and the other route is through the ON reverse conductive semiconductor switch SW4 and OFF reverse conductive semiconductor switch SW2.

The inductor L of the alternating-current power source 20 accumulates magnetic energy due to the currents load and Imers.

### (Charge N Mode) (FIG. 3C)

At a time T7 when the above parallel N mode has continued for a given time period, the control circuit 110 switches the gate signals SG1 and SG4 to OFF signals. The gate signal

SGL is kept being an ON signal and the other gate signals are kept being OFF signals.

The reverse conductive semiconductor switches SW1 and SW4 are turned off and the current flows as shown in FIG. 3C.

The current flowing through the reverse conductive semiconductor switches SW1 and SW4 is cut off. Then, the magnetic energy accumulated in the inductor L0 and the like causes a current to flow into the positive electrode of the capacitor CM via the OFF reverse conductive semiconductor switch SW3. The capacitor CM is charged and the current flowing out from the negative electrode of the capacitor CM returns to the alternating-current power source 20 via the OFF reverse conductive semiconductor switch SW2 and inductor L0. After the magnetic energy accumulated in the inductor L0 and the like is exhausted and the charge of the capacitor CM is completed, the current Imers is cut off.

Since the current Imers is cut off, the magnetic energy accumulated in the inductor L by the currents Imers and Iload causes a current to flow through the load 30. Consequently, the current load flowing through the load 30 is increased and the voltage of the load 30 is also increased.

### (Discharge N Mode) (FIG. 3A)

At a time T8 corresponding to the predetermined cycle of frequency f, the control circuit 110 switches the gate signals SG1 and SG4 to ON signals. The gate signal SGL is kept being an ON signal and the other gate signals are kept being OFF signals. Since the current Imers is cut off, the switching operation is soft switching.

The reverse conductive semiconductor switches SW1 and SW4 are turned on and the current resumes flowing as shown in FIG. 3A.

The control circuit 110 repeats the above operation along with controlling the duty ratio of the gate signals SG1 and SG4 so that the current flowing through the inductor L and detected by the ammeter 300 has a target waveform while the output voltage of the alternating-current power source 20 is negative.

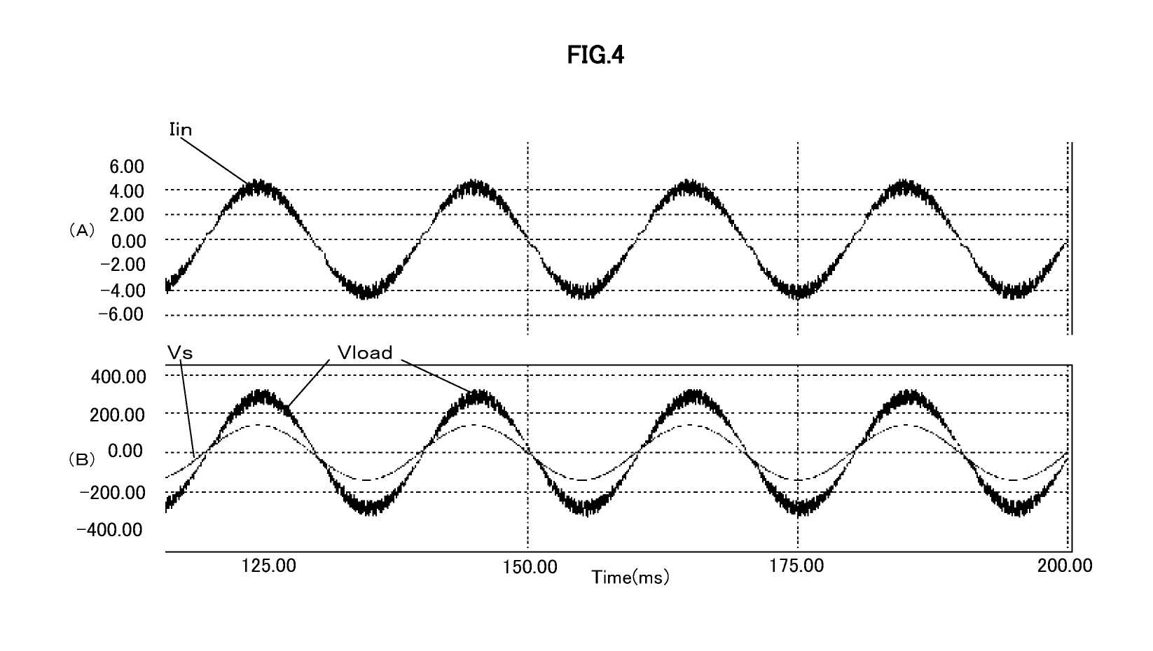

With the above modes being repeated, the voltage Vload across the load 30, output voltage Vs of the alternating-current power source 20, and current Iin flowing through the inductor L and alternating-current power source 20 have the relationship, for example, as shown in FIGS. 4A and 4B.

FIG. 4 show the above relationship with the time (ms) plotted as abscissa when the control circuit 110 conducts PFC control with a frequency of 6 kHz so that the current Iin exhibits a sinusoidal wave with a peak of 4 A. Here, the alternating-current power source 20 has output of 50 Hz, the sinusoidal wave has a peak of 141 V, the inductor L has inductance 10 mH, the inductor L0 has inductance of 100 μH, the capacitor CM has capacitance of 0.2 μF, and the load 30 has resistance of 144Ω.

FIG. 4A shows the chronological change of the current Iin (A) and the FIG. 4B shows the chronological change of the voltages Vs (V) and Vload (V).

As shown in FIGS. 4A and 4B, the voltage Vs having a peak of 144V is boosted and the voltage Vload having a peak of 288V is applied to the load 30. The power factor of the power supplied from the alternating-current power source 20 to the load 30 is nearly 1 and the current Iin has a peak of nearly 4 A.

The alternating-current power source 20 outputs power of 50 Hz, 144V at the peak, and 4 A and a voltage of 50 Hz and 288V at the peak is applied to the load 30 having resistance of 144Ω. Therefore, the power output from the alternating-current power source 20 and the power consumed by the load 30 are nearly equal.

The relationship among the gate signals SG2 and SG3 of the current, the current Iin flowing through the inductor L and alternating-current power source 20, and the target waveform of the PFC control of the control circuit 110 from the time T0 to the time T4 is, for example, as shown in FIG. 5.

At the time T1, the current direction switching part 200 cuts off the current flowing through the reverse conductive semiconductor switch SWL and a current starts to flow through the reverse conductive semiconductor switch SWR. The current Iin increases from the time T1 to the time T3, and decreases from the time T3 to the time T4. The current Iin after the time T4 is similar to that from the time T1 to the time T4.

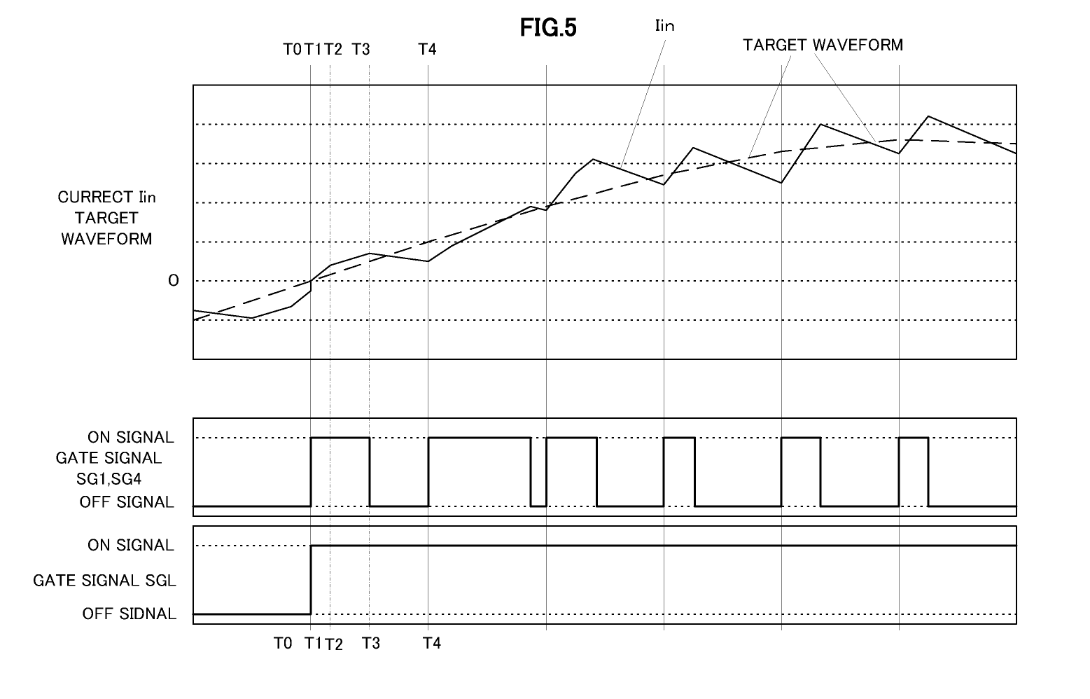

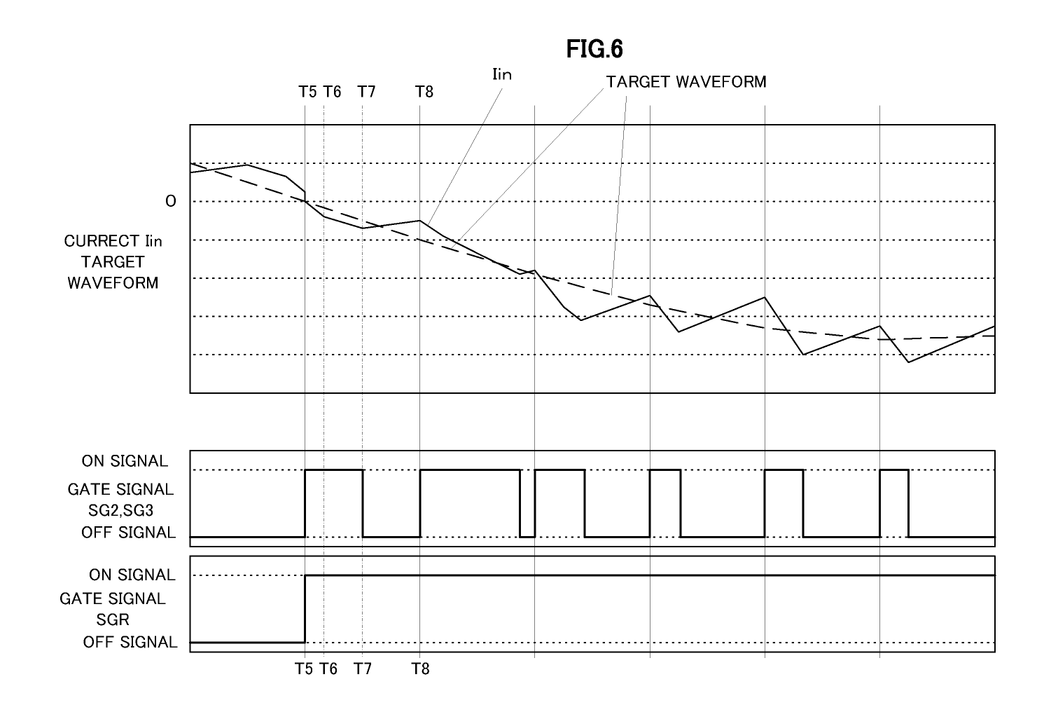

The relationship among the gate signals SG1 and SG4 of the current, the current Iin flowing through the inductor L and alternating-current power source 20, and the target waveform of the PFC control of the control circuit 110 from the time T5 to the time T8 is, for example, as shown in FIG. 6.

Like from the time T1 to the time T4, at the time T5, the current direction switching part 200 cuts off the current flowing through the reverse conductive semiconductor switch SWR and a current starts to flow through the reverse conductive semiconductor switch SWL. The current Iin decreases from the time T5 to the time T7, and increases from the time T7 to the time T8. The current Iin after the time T8 is similar to that from the time T5 to the time T8.

As shown in FIGS. 4A, 4B, 5, and 6, the current Iin is adjusted through the PWM-PFC control by the control circuit 110 so that it almost has a target waveform.

As described above, in the power conversion device 1, the control circuit 110 feeds back the current Iin flowing through the inductor L and alternating-current power source 20 for PWM-PFC control on the gate signals SG1 to SG4. Consequently, the power factor of the power output from the alternating-current power source 20 can be nearly 1. Furthermore, since almost all switching operations are soft switching, switching loss and noise are low. Furthermore, since the control circuit 110 feeds back the current Iin so that it has a target waveform, the power supplied from the alternating-current power source 20 can be adjusted. Since the power supplied from the alternating-current power source 20 is adjusted, the current flowing through the load 30 becomes constant regardless of the load 30. Furthermore, the inductor L0 protects the elements of the full-bridge MERS 100 from abruptly rising current.

### Embodiment 2

A direct-current voltage can be applied to a load by using a diode bridge as the current direction switching part 200 of the power conversion device 1.

A power conversion device 2 according to this embodiment is constructed by, as shown in FIG. 7, replacing the current direction switching part 200 with a current direction switching part 210 comprising a diode bridge and connecting a smoothing capacitor CC to the load 30 in the power conversion device 1 of FIG. 1.

The current direction switching part 210 is a diode bridge circuit comprising four diodes DU, DV, DX, and DY. The anode of the diode DU and the cathode of the diode DX are connected to the input terminal I1. The anode of the diode DV and the cathode of the diode DY are connected to the input terminal I2. The cathode of the diode DU and the cathode of the diode DV are connected to the output terminal O1. The anode of the diode DX and the anode of the diode DY are connected to the output terminal O2.

The control circuit 110 controls the gate signals SG1 to SG4 in the same manner as in the power conversion device 1 according to Embodiment 1.

The current direction switching part 210 rectifies the current entered from the input terminals I1 and I2 and outputs it from the output terminals O1 and O2.

The smoothing capacitor CC smoothes the voltage output from between the output terminals O1 and O2 of the current direction switching part 210 and supplies it to the load 30.

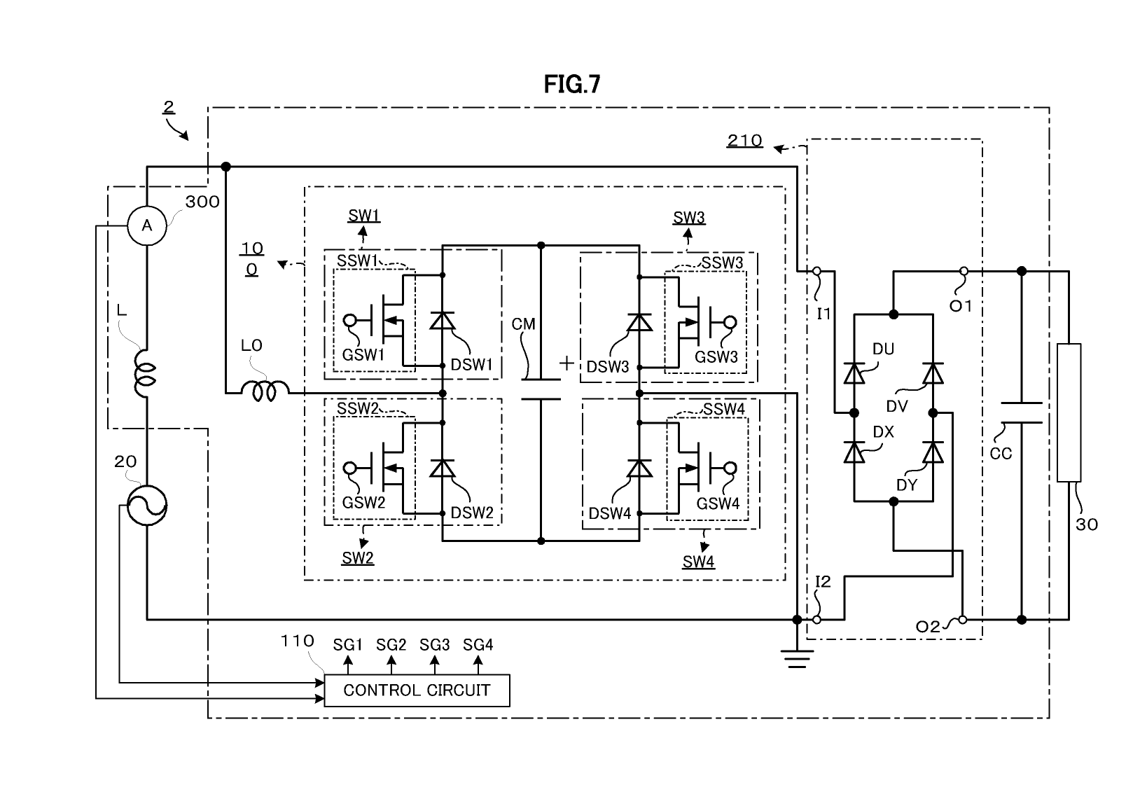

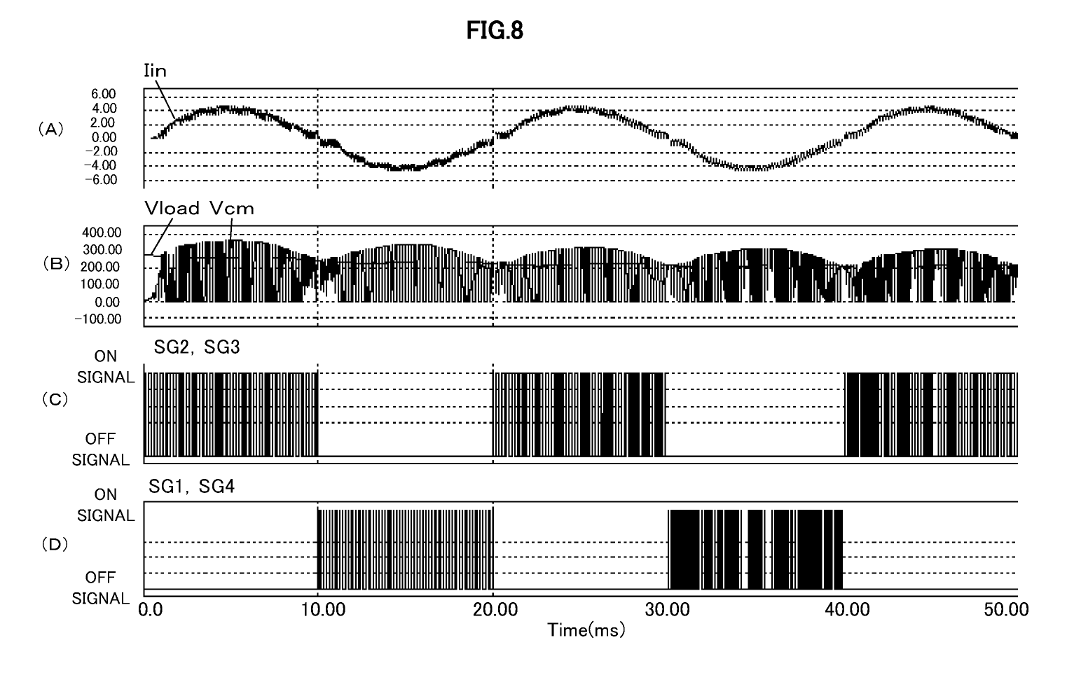

The relationship among the voltage Vload applied to the load 30 by the power conversion device 2, the voltage Vcm of the capacitor CM, the current Iin flowing through the alternating-current power source 20, and the gate signals SG1 to SG4 is, for example, as shown in FIGS. 8A to 8D.

FIG. 8 show the above relationship with the time (ms) plotted as abscissa when the control circuit 110 conducts PFC-control with PWM of a frequency of 6 kHz so that the current Iin has a peak of nearly 4 A. Here, the alternating-current power source 20 has output of 50 Hz, the sinusoidal wave has a peak of 141 V, the inductor L has inductance of 10 mH, the inductor L0 has inductance of 100 μH, the capacitor CM has capacitance of 0.2 μF, the load 30 has resistance of 144Ω, and the smoothing capacitor CC has capacitance of 200 μF.

FIG. 8A shows the chronological change of the current Iin and the FIG. 8B shows the chronological change of the voltages Vload (V) and Vcm (V). Furthermore, FIG. 8C shows the chronological change of the gate signals SG2 and SG3 and FIG. 8D shows the chronological change of the gate signals SG1 and SG4.

As shown in FIGS. 8A to 8D, in accordance with whether the output voltage of the alternating-current power source 20 is positive or negative, the gate signals SG1 to SG4 are switched to ON signals/OFF signals so as to boost the output voltage of the alternating-current power source 20. Consequently, the voltage Vload converted to a direct current of nearly 260 V is applied to the load 30. The power factor of the power supplied from the alternating-current power source 20 is nearly 1 and the current Iin has a peak of nearly 4 A.

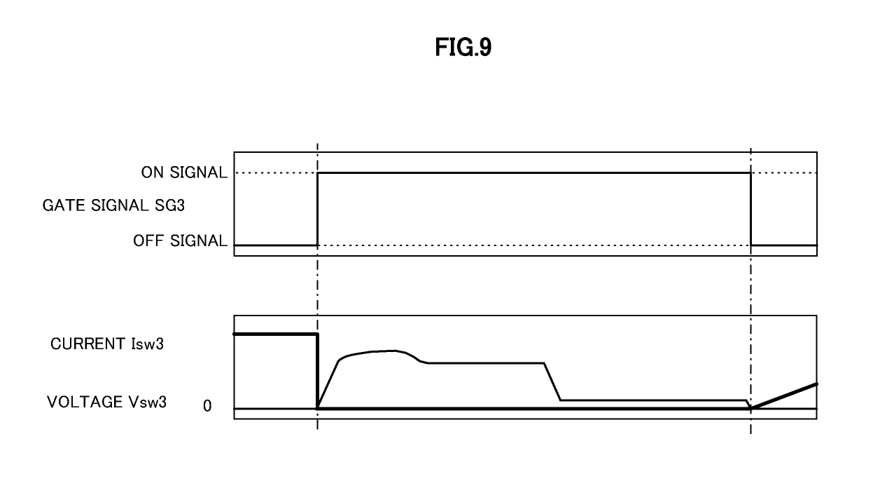

As the gate signal SG3 is switched to an ON signal/an OFF signal as shown in FIG. 8C, the current Isw3 and voltage Isw3 of the reverse conductive semiconductor switch SW3 changes as shown in FIG. 9.

FIG. 9 shows the voltage Vsw3 and current Isw3 in the same range for easier understanding.

As shown in FIG. 9, the current Isw3 becomes nearly zero when the gate signal SG3 is switched from an OFF signal to an ON signal, and the voltage Vsw3 becomes nearly zero when the gate signal SG3 is switched from an ON signal to an OFF signal. From this, it is understood that the switching operation is soft switching. The same applies to the reverse conductive semiconductor switches SW1, SW2, and SW4.

As in the power conversion device 1 according to Embodiment 1, the control circuit 110 controls the gate signals SG1 to FG4 so that the current Iin flowing through the inductor L and alternating-current power source 20 has a target waveform. Then, the power supplied from the alternating-current power source 20 is constant regardless of the load 30.

The power conversion devices 1 and 2 are applicable to a three-phase circuit by parallel-connecting them to the phases of a three-phase alternating-current power source. In such a case, a load is common to the phases and, therefore, the power source of each phase should be insulated by a transducer. Then, leakage reactance of the transformer can be utilized.

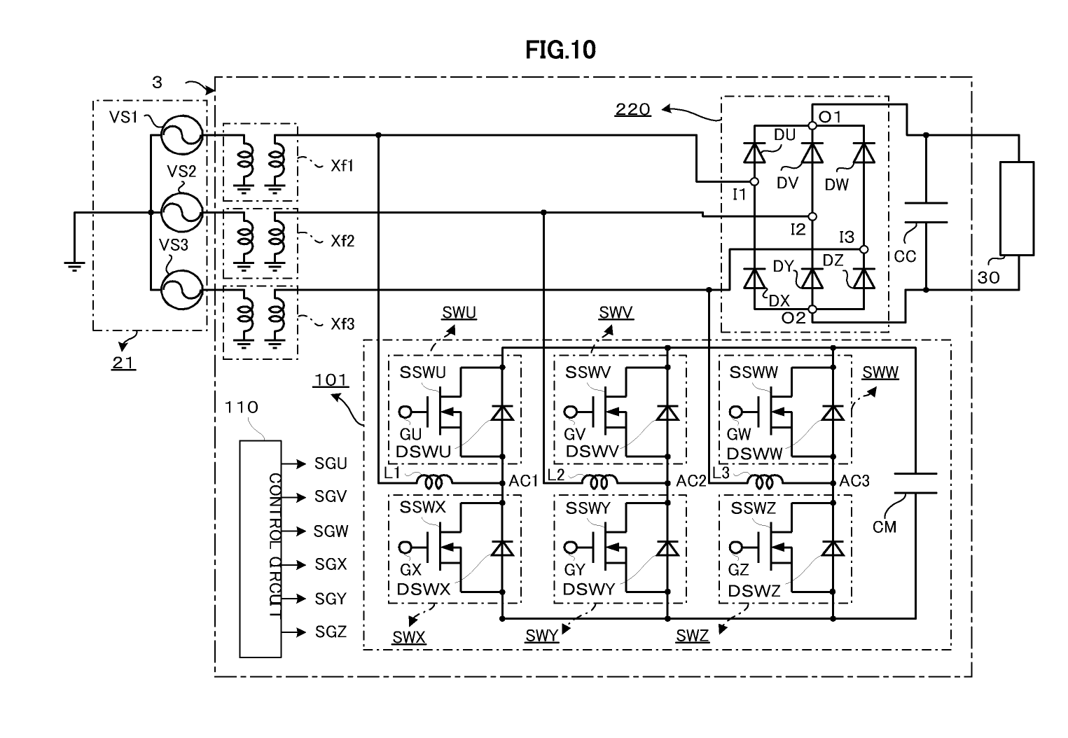

Furthermore, three full-bridge MERSs can be parallel-connected to a three-phase alternating-current diode rectifier to balance the input current even if the input voltage is unbalanced. When the input current is balanced, as shown in FIG. 10, a three-phase bridge MERS 101 can be used.

### Embodiment 3

FIG. 10 shows a power conversion device 3 in which the power conversion device 2 according to Embodiment 2 is applied to a three-phase circuit.

The power conversion device 3 according to this embodiment is a device boosting the output voltage of a three-phase alternating-current power source 21 and supplying it to the load 30. The power conversion device 3 comprises, as shown in FIG. 10, inductors L1 to L3, a three-phase bridge MERS 101, a control circuit 110, a current direction switching part 220, and a smoothing capacitor CC.

The three-phase bridge MERS 101 comprises six reverse conductive semiconductor switches SWU to SWZ, alternating-current terminals AC1, AC2, and AC3, and transformers Xf1, Xf2, and Xf3.

The reverse conductive semiconductor switches SWU to SWZ of the three-phase bridge MERS 101 are each comprises a diode part DSWx (x=U, V, W, X, Y or Z), a switch part SSWx parallel-connected to the diode part DSWx, and a gate Gx provided to the switch part SSWx.

The current direction switching part 220 comprises input terminals I1, I2, and I3, output terminals O1, O2, and O3, and diodes DU to DZ.

The alternating-current power source 21 is denoted by an equivalent circuit to three alternating-current voltage sources VS1, VS2, and VS3. The alternating-current voltage sources VS1, VS2, and VS3 are connected to the input terminals I1, I2, and I3 of the current direction switching part 220 via the transformers Xf1, Xf2, and Xf3.

The load 30 is connected between the output terminals O1 and O2 of the current direction switching part 220.

The anode of the diode DU and the cathode of the diode DX are connected to the input terminal I1 of the current direction switching part 220. The anode of the diode DV and the cathode of the diode DY are connected to the input terminal I2. The anode of the diode DW and the cathode of the diode DZ are connected to the input terminal I3. The cathodes of the diodes DU, DV, and DW are connected to the output terminal O1 of the current direction switching part 220. The anodes of the diodes DX, DY, and DZ are connected to the output terminal O2.

The inductors L1 to L3 are connected to the alternating-current terminals AC1 to AC3 of the three-phase bridge MERS 101 at one end and to the input terminals I1 to I3 of the current direction switching part 220 at the other end.

The anode of the diode part DSWU and the cathode of the diode part DSWX are connected to the alternating-current terminal AC1 of the three-phase bridge MERS 101. The anode of the diode part DSWV and the cathode of the diode part DSWY are connected to the alternating-current terminal AC2. The anode of the diode part DSWW and the cathode of the diode part DSWZ are connected to the alternating-current terminal AC3.

In the three-phase bridge MERS 101, the cathodes of the diodes parts DSWU, DSWV, and DSWW and the positive electrode of the capacitor CM are connected, and the anodes of the diodes parts DSWX, DSWY, and DSWZ and the negative electrode of the capacitor CM are connected.

The control circuit 110 receives the voltage output from the alternating-current power source 21.

The alternating-current power source 21 is a power source outputting a three-phase alternating current and, for example, an alternating-current power generator.

The transformers Xf1 to Xf3 generate a magnetic field changing according to the output of the alternating-current power source 21 on the primary coil and transmit the magnetic field to the secondary coil coupled by mutual inductance to convert it to a current again. The secondary coils of the transformers Xf1 to Xf3 are adjusted to generate leakage inductance of approximately 10 mH.

The inductors L1 to L3 are, for example, small coils of 100 μH, smoothing the rising edge of the current flowing through the three-phase bridge MERS 101.

The reverse conductive semiconductor switches SWU to SWZ are, for example, N-channel silicon MOSFETs, being turned on/off by signals received by the gates GU to GW.

As the reverse conductive semiconductor switches SWU to SWZ are turned on/off, the capacitor CM accumulates/regenerates the magnetic energy accumulated in the leakage inductance of the secondary coils of the transformers Xf1 to Xf3 as static energy.

The current direction switching part 220 rectifies the power entered from the input terminals I1 to I3 and outputs it from the output terminals O1 and O2.

The smoothing capacitor CC smoothes the power output from between the output terminals O1 and O2 of the current direction switching part 220 and supplies it to the load 30.

The control circuit 110 outputs gate signals SGU to SGZ presenting an ON signal or an OFF signal to the gates GU to GZ of the reverse conductive semiconductor switches SWU to SWZ. The reverse conductive semiconductor switches SWU to SWZ are turned on/off based on whether the gate signals SGU to SGZ are an ON signal or OFF signal.

The gate signals SGU to SGZ have a predetermined frequency f and a variable duty ratio.

When the output voltage of the alternating-current voltage source VS1 is positive, the control circuit 110 switches the gate signal SGU between an ON signal and an OFF signal at a frequency f and with a constant duty ratio, and keeps the gate signal SGX being an OFF signal. On the other hand, when the output voltage of the alternating-current voltage source VS1 is negative, the control circuit 110 switches the gate signal SGX between an ON signal and an OFF signal at a frequency f and with a constant duty ratio, and keeps the gate signal SGU being an OFF signal.

Similarly, when the output voltage of the alternating-current voltage source VS2 is positive, the control circuit 110 switches the gate signal SGV between an ON signal and an OFF signal, and keeps the gate signal SGY being an OFF signal. On the other hand, when the output voltage of the alternating-current voltage source VS2 is negative, the control circuit 110 switches the gate signal SGY between an ON signal and an OFF signal, and keeps the gate signal SGV being an OFF signal.

Furthermore, when the output voltage of the alternating-current voltage source VS3 is positive, the control circuit 110 switches the gate signal SGW between an ON signal and an OFF signal, and keeps the gate signal SGZ being an OFF signal. On the other hand, when the output voltage of the alternating-current voltage source VS3 is negative, the control circuit 110 switches the gate signal SGZ between an ON signal and an OFF signal, and keeps the gate signal SGW being an OFF signal.

In the power conversion device 3, the control circuit 110 does not need to conduct PFC control. Without PFC control, a current having nearly a sinusoidal waveform flows through the alternating-current voltage sources VS1 to VS3.

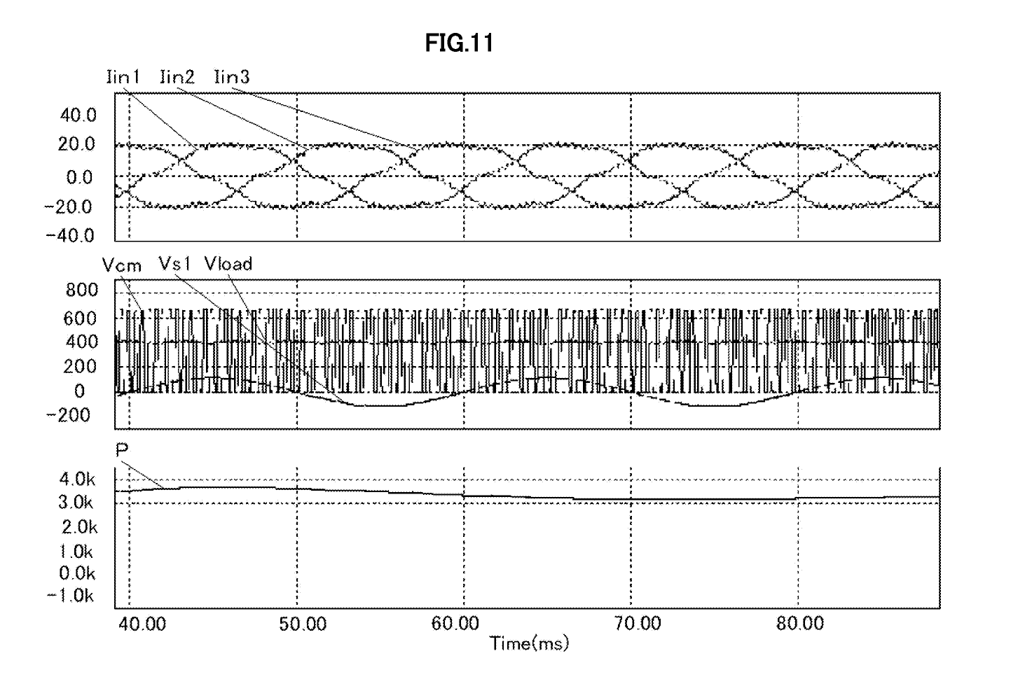

The chronological change of the currents Iin1 to Iin3 flowing through the alternating-current voltage sources VS1 to VS3, the voltage Vcm of the capacitor CM, the voltage Vs1 output from the alternating-current voltage source VS1, the voltage Vload applied to the load 30, and the power P consumed by the load 30 are as shown in FIGS. 11A to 11C.

FIG. 11 show the above relationship with the time (ms) plotted as abscissa when the control circuit 110 controls the gate signals SGU to SGZ at a frequency of 6 kHz and with a duty ratio of 0.5. Here, the alternating-current power source 21 has output of 50 Hz, the three-phase alternating-current voltage has a peak of 14 V, the transformers Xf1 to Xf3 have leakage inductance of 10 mH, the inductors L1 to L3 have inductance of 100 μH, the capacitor CM has capacitance of 0.2 μf, the load 30 has resistance of 144Ω, and the smoothing capacitor CC has capacitance of 200 μF.

FIG. 11A shows the chronological change of the currents Iin1 to Iin3, the FIG. 11B shows the chronological change of the voltages Vcm (V), Vs1 (V), and Vload (V), and FIG. 11C shows the chronological change of the power P (W).

As shown in FIGS. 11A to 11C, the output of the alternating-current power source 21 is boosted and the voltage Vload converted to a direct current of nearly 400 V is applied to the load 30. The power factor of the power output from the alternating-current power source 20 is high and the load 30 consumes approximately 3.5 kW of power.

The power conversion device 3 can adjust the output power of the alternating-current power source 21 by adjusting the duty ratio of the gate signals SGU to SGZ of the control circuit 110. From the above-described relationship of the modes such as the charge P mode etc., the power supplied from the alternating-current power source 21 is increased as the duty ratio is raised. Hence, desired power can be obtained by adjusting the duty ratio.

As described above, in the power conversion devices 1 and 2 of the embodiments, the reverse conductive semiconductor switches of a full-bridge MERS are turned on/off in accordance with whether the output voltage of the alternating-current power source is positive or negative. Consequently, the direction in which the current flows is adjusted and the power supplied from the alternating-current power source to the load is adjusted. Furthermore, feedback control on the current flowing through the inductor L leads to improvement in the power factor.

In the power conversion device 3 of the embodiment, in accordance with whether the output voltage in each phase of a three-phase alternating-current power source is positive or negative, the reverse conductive semiconductor switches of a three-phase bridge MERS are turned on/off, and the current is rectified. Consequently, the power conversion device 3 can adjust the power supplied from the three-phase alternating-current power source to the load.

### Embodiment 4

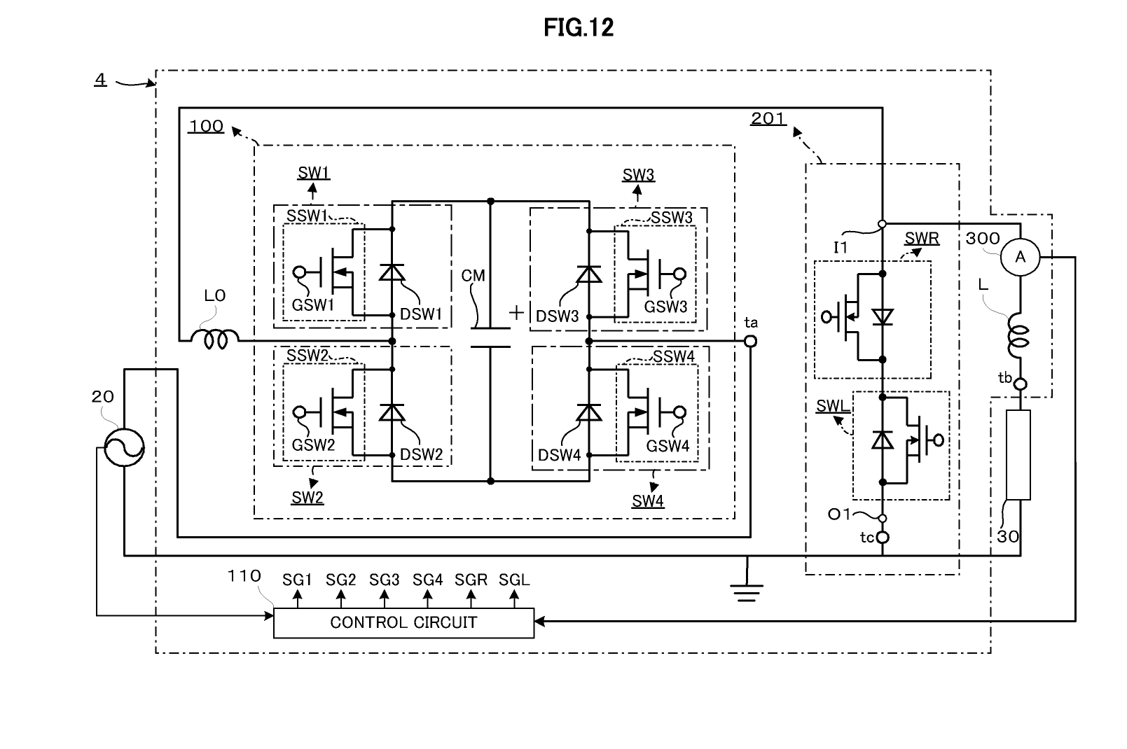

As an applied embodiment of the power conversion device 1 in FIG. 1, a power conversion device 4 functioning as a buck converter is shown in FIG. 12.

The power conversion device 4 comprises a current direction switching part 201 in which the reverse conductive semiconductor switches SWR and SWL are series-connected between the input terminal I1 and output terminal O1 instead of the current direction switching part 200 in FIG. 1.

As shown in FIG. 12, the alternating-current power source 20 is connected between the connection terminal to and a grounded line. The load 30 is connected between the connection terminal tb and the grounded line. The connection terminal tc is connected to the grounded line. With such a connection, the power conversion device 4 functions as a buck converter. The ammeter 300 is so connected as to be able to measure the current flowing through the load 30.

The control circuit 110 feeds back the current flowing through the inductor L as in the above-described control. The power supplied from the alternating-current power source 20 is adjusted by shifting the peak and/or phase of a target current. The pair of reverse conductive semiconductor switches to be turned on/off is switched according to the direction of the current.

When the output voltage of the alternating-current power source 20 is positive, the control circuit 110 turns on/off the reverse conductive semiconductor switches SW1 and SW4 and keeps the reverse conductive semiconductor switches SW2, SW3, and SWL being off and the reverse conductive semiconductor switch SWR being on. On the other hand, when the output voltage of the alternating-current power source 20 is negative, the control circuit 110 turns on/off the reverse conductive semiconductor switches SW2 and SW3 and keeps the reverse conductive semiconductor switches SW1, SW4, and SWR being off and the reverse conductive semiconductor switch SWL being on.

A current flows through the load 30 via the alternating-current power source 20 and inductor L while the full-bridge MERS 100 conducts the current. The inductor L accumulates magnetic energy via the alternating-current power source 20. Meanwhile, the inductor L and load 30 is supplied with power from the alternating-current power source 20.

The magnetic energy accumulated in the inductor L causes a current to flow through the load 30 while the full-bridge MERS 100 cuts off the current. The current flowing through the inductor L flows through the load 30 and current direction switching part 200 and returns to the inductor L. Since no power is supplied from the alternating-current power source, the magnetic energy in the inductor L is consumed by the load 30 and the current flowing through the load 30 is gradually diminished.

As the full-bridge MERS 100 conducts or cuts off the current, the power supplied to the load 30 is reduced.

Furthermore, with the connection points of the connection terminals Tb and Tc being switched in the power conversion device 1, the power conversion device 1 works as a boost buck converter.

### Embodiment 5

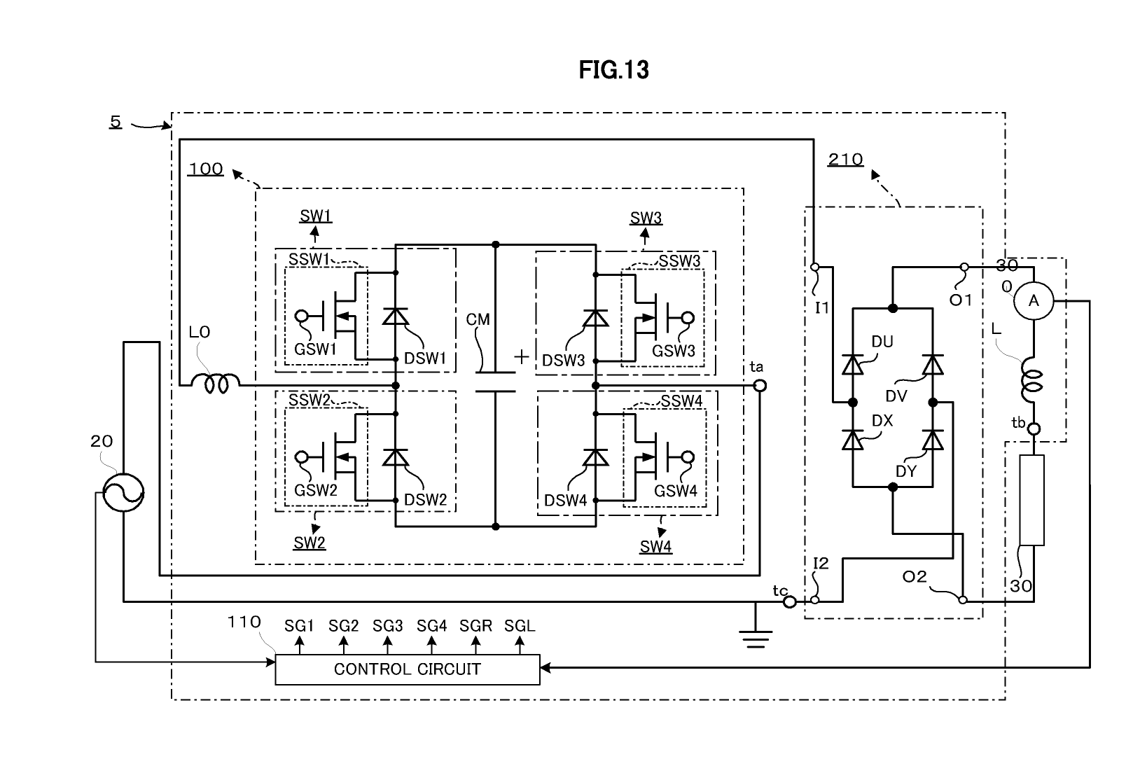

FIG. 13 shows a power conversion circuit 5 constructed by replacing the current direction switching part 201 in the power conversion device 4 in FIG. 12 with a current direction switching part 210 comprising a diode bridge.

In the power conversion circuit 5, one end of the inductor L0 is connected to the input terminal I1 of the current direction switching part 210 and the connection terminal tc is connected to the input terminal I2. The grounded line is connected to the connection terminal tc, the other end of the inductor L is connected to the output terminal O1, and one end of the inductor L is connected to the connection terminal tb. Furthermore, the load 30 is connected between the output terminal O2 and connection terminal tb. The power conversion device 5 is constructed by eliminating the smoothing capacitor CC and changing the connection scheme in the power conversion device 2 shown in FIG. 7.

The power conversion circuit 5 lowers the output voltage of the alternating-current power source 20 and applies it to the load 30. Consequently, the power supplied to the load 30 is adjusted.

As described above, the inductor L is series-connected between the alternating-current power source and load and the full-bridge MERS 100, to which the inductor L0 having inductance lower than the inductor L is series-connected, is parallel-connected or series-connected to the load 30. Then, among the four reverse conductive semiconductor switches constituting the full-bridge MERS 100, either a pair of reverse conductive semiconductor switches SW2 and SW3 or a pair of reverse conductive semiconductor switches SW1 and SW4, which corresponds to the direction of the current flowing through the alternating-current power source 20, is turned on/off at a frequency equal to or higher than the frequency of the alternating-current voltage output from the power source 20. The other pair is kept being off, whereby the power supplied from the alternating-current power source 20 can be increased or decreased for controlling the waveform and improving the power factor.

Furthermore, a direct current or alternating current can selectively be supplied to the load 30 by selecting the current direction switching part 200, 201, or 210.

The present invention is not confined to the above embodiments and various applications and modification are available.

For example, the capacitor CM can be a nonpolar capacitor or polar capacitor.

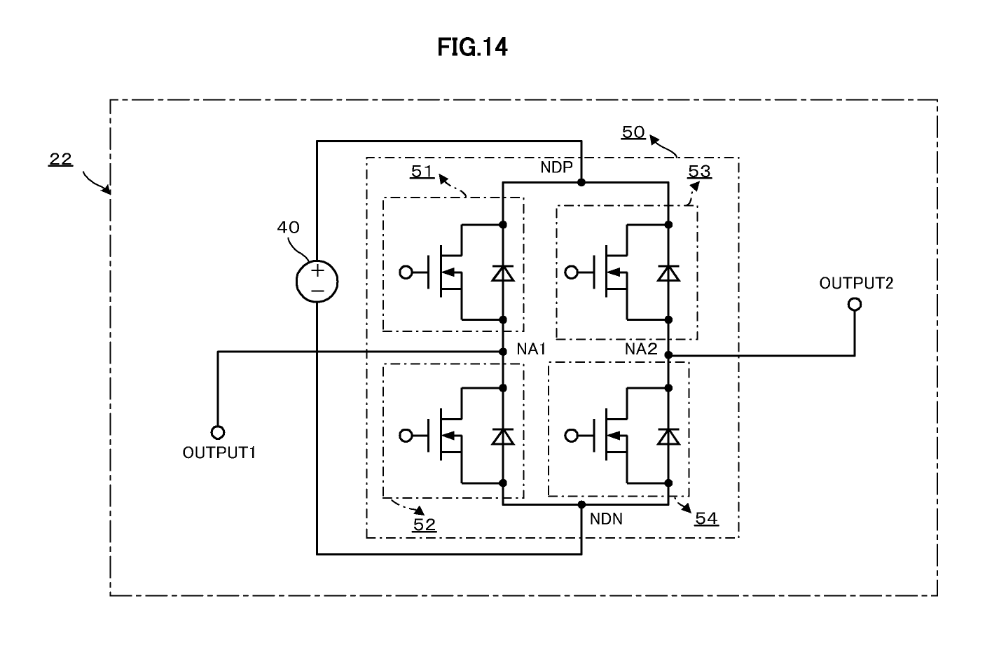

The power conversion devices 1, 2, and 4 can be connected to a direct-current power source. For example, as shown in FIG. 14, a direct-current power source 40 is connected to an orthogonal transducer 50 to create an alternating-current power source 22. The orthogonal transducer 50 is, for example, a bridge circuit comprising four reverse conductive semiconductor switches 51 to 54 as shown in FIG. 14. The drains of the reverse conductive semiconductor switches 51 and 53 are connected to a direct-current terminal NDP. The sources of the reverse conductive semiconductor switches 52 and 54 are connected to a direct-current terminal NDN. Furthermore, the source of the reverse conductive semiconductor switch 51 and the drain of the reverse conductive semiconductor switch 52 are connected to an alternating-current terminal NA1. The source of the reverse conductive semiconductor switch 53 and the drain of the reverse conductive semiconductor switch 54 are connected to an alternating-current terminal NA2. The positive and negative electrodes of the direct-current power source 40 are connected to the direct-current terminals NDP and NDN, respectively.

The alternating-current terminals NA1 and NA2 function as the output terminals of the alternating-current power source 22. For example, a case is discussed in which the alternating-current terminal NA1 is grounded and a pair of reverse conductive semiconductor switches 51 and 54 and a pair of reverse conductive semiconductor switches 52 and 53 are turned on/off at 50 Hz so that they are different from each other. When the pair of reverse conductive semiconductor switches 52 and 53 is on and the pair of reverse conductive semiconductor switches 51 and 54 is off, a positive potential is output from the alternating-current terminal NA2. On the other hand, when the pair of reverse conductive semiconductor switches 51 and 54 is on and the pair of reverse conductive semiconductor switches 52 and 53 is off, a negative potential is output from the alternating-current terminal NA2. As the reverse conductive semiconductor switches 51 to 54 are turned on/off, a rectangular waveform of 50 Hz is output from the alternating-current terminal NA2.

If the alternating-current power source 22 is connected to the power conversion device 1, 2, 4, or 5 instead of the alternating-current power source 20, the control circuit 110 controls the gate signals SG1 to SG4 so that the current flowing through the alternating-current power source 22 is an alternating current having the same cycle as the voltage output from the alternating-current power source 22. Even if the direct-current power source 40 is something unstable in output such as a solar power generator and wind power generator, the control circuit 110 forcefully controls the current flowing through the alternating-current power source 22 to have a target waveform.

Furthermore, in the above embodiments, the control circuit 110 conducts PFC control based on PWM. This is not restrictive. For example, PFC control based on a pulse pattern can be used.

Furthermore, in the above embodiments, the control circuit 110 controls the direction of the current conducted or cut off by the current direction switching part 200 or 201. This is given by way of example. Any other method can be used for such a control.

For example, a circuit outputting an ON signal when the output voltage of the alternating-current power source is positive and an OFF signal when the output voltage of the alternating-current power source is negative can be connected to the gate GSWR of the reverse conductive semiconductor switch SWR. Alternatively, a circuit outputting an OFF signal when the output voltage of the alternating-current power source is positive and an ON signal when the output voltage of the alternating-current power source is negative can be connected to the reverse conductive semiconductor switch SWL.

Furthermore, in the above embodiments, the power conversion devices 1, 2, 4, and 5 are provided with the inductor L0 for smoothing the rising edge of the current flowing through the full-bridge MERS 100. This is not restrictive. For example, the power conversion devices 1, 2, 4, and 5 do not need to be provided with the inductor L0.

Furthermore, in the above embodiments, the voltage is accumulated in the capacitor CM when the voltage output from the alternating-current power source 20 is switched between positive and negative. This is given by way of example. For example, by adjusting the PWM frequency, it is possible to switch the voltage output from the alternating-current power source 20 between positive and negative when no voltage is accumulated in the capacitor CM.

For example, in the above embodiments, the reverse conductive semiconductor switches are N-channel MOSFETs comprising a switch and its parasitic diode. However, this is given by way of example. The reverse conductive semiconductor switches can be field effect transistors, insulated gate bipolar transistors (IGBTs), gate turn-off thyristors (GTOs), or those comprising a combination of a diode and a switch as long as they are reverse conductive switches.

Furthermore, in the above explanation, the control circuit 110 is a circuit conducting the above control. This is not restrictive. For example, the control circuit 110 can be a computer such as a microcontroller comprising a CPU (central processing unit) and a storage means such as a RAM (random access memory) and ROM (read only memory) (“a microcomputer,” hereafter).

Particularly, when the control circuit 110 is a microcomputer, the reverse conductive semiconductor switches and microcomputer are combined so that the reverse conductive semiconductor switches are turned on/off in accordance with a signal 0 or 1 output from the microcomputer. In this way, the reverse conductive semiconductor switches are turned on/off according to the output of the microcomputer, whereby the number of parts can be reduced.

In such a case, for example, a program to output the above gate signals can be stored in the microcomputer in advance.

This application is based on Japanese Patent Application No. 2009-247310 filed on Oct. 28, 2009, and including specification, claims, drawings and summary. The disclosure of the above Japanese Patent Application is incorporated herein by reference in its entirety.

### DESCRIPTION OF REFERENCE NUMERALS

1, 2, 3, 4 Power conversion device
20, 21, 22 Alternating-current power source
30 Load
40 Direct-current power source
50 Orthogonal transducer
100 Full-bridge MERS
101 Three-phase bridge MERS
110 Control circuit
200, 201, 210, 220 Current direction switching part
SW1, SW2, SW3, SW4, SWR, SWL, SWU, SWV, SWW, SWX. SWY, SWZ, 51, 52, 53, 54 Reverse conductive semiconductor switch
L, L0, L1, L2, L3 Reactor
DR, DL, DU, DV, DX, DY diode
CC Smoothing capacitor
DCP, DCN, NDP, NDN direct-current terminal
AC1, AC2, NA1, NA2 alternating-current terminal
I1, I2, I3 Input terminal
O1, O2 output terminal
CM Capacitor
SSW1, SSW2, SSW3, SSW4, SSWR, SSWL, SSWU, SSWV, SSWW, SSWX, SSWY, SSWZ Switch part
DSW1, DSW2, DSW3, DSW4, DSWR, DSWL, DSWU, DSWV, DSWW, DSWX, DSWY, DSWZ Diode part
GSW1, GSW2, GSW3, GSW4, GSWR, GSWL, GU, GV, GW, GX, GY, GZ Gate
SG1, SG2, SG3, SG4, SGR, SRL, SGU, SGV, SGW, SGX, SGY, SGZ Gate signal

1. A power conversion device, comprising:
an inductor having one end connected to one end of an alternating-current power source having the other end connected to a reference potential point;
a current direction switching means comprising an input terminal connected to the other end of the inductor and an output terminal connected to one end of a load, and switching the current conduction direction by conducting the current flowing from the input terminal to the output terminal and cutting off the current flowing from the output terminal to the input terminal when the output voltage of the alternating-current power source is positive, and conducting the current flowing from the output terminal to the input terminal and cutting off the current flowing from the input terminal to the output terminal when the output voltage of the alternating-current power source is negative;
a magnetic energy recovery switch comprising first and second alternating-current terminals, first and second direct-current terminals, first through fourth diodes, first through fourth self arc-extinguishing elements, and a capacitor, in which the anode of the first diode and the cathode of the second diode are connected to the first alternating-current terminal, the cathodes of the first and third diodes and one electrode of the capacitor are connected to the first direct-current terminal, the anodes of the second and fourth diodes and the other electrode of the capacitor are connected to the second direct-current terminal, the anode of the third diode and the cathode of the fourth diode are connected to the second alternating-current terminal, the first, second, third, and fourth self arc-extinguishing elements are parallel-connected to the first, second, third, and fourth diodes, respectively, the input terminal is connected to the first alternating-current terminal, and the other end of the load and the reference potential point are connected to the second alternating-current terminal; and
a control means controlling the self arc-extinguishing elements to turn on/off them,
wherein the control means repeatedly switches on/off either a pair of the second and third self-extinguishing elements or a pair of the first and fourth self-extinguishing elements, which corresponds to the positive/negative voltage output from the alternating-current power, at a frequency equal to or higher than the frequency of the output voltage of the alternating-current power source, and keeps the other pair being off.

2. The power conversion device according to claim 1, further comprising a current detection means detecting the current flowing through the inductor, wherein:
the control means turns on/off the first through fourth self arc-extinguishing elements so that the current detected by the current detection means has a target waveform.

3. The power conversion device according to claim 1, wherein:
the control means turns on/off the first through fourth self arc-extinguishing elements so that the power factor of the power supplied from the alternating-current power source is nearly 1.

4. The power conversion device according to claim 1, further comprising a second inductor smoothing the rising edge of a current flowing through the magnetic energy recovery switch.

5. A power conversion device, comprising:
an inductor having one end connected to one end of an alternating-current power source having the other end connected to a reference potential point;
a current direction switching means comprising first and second input terminals and first and second output terminals, in which a series circuit of the alternating-current power source and inductor is connected between the first and second input terminals and a load is connected between the first and second output terminals for rectifying an alternating current entered from the first and second input terminals to a direct current and outputting it from between the first and second output terminals;
a magnetic energy recovery switch comprising first and second alternating-current terminals, first and second direct-current terminals, first through fourth diodes, first through fourth self arc-extinguishing elements, and a capacitor, in which the anode of the first diode and the cathode of the second diode are connected to the first alternating-current terminal, the cathodes of the first and third diodes and one electrode of the capacitor are connected to the first direct-current terminal, the anodes of the second and fourth diodes and the other electrode of the capacitor are connected to the second direct-current terminal, the anode of the third diode and the cathode of the fourth diode are connected to the second alternating-current terminal, the first, second, third, and fourth self arc-extinguishing elements are parallel-connected to the first, second, third, and fourth diodes, respectively, the first input terminal is connected to the first alternating-current terminal, and the second input terminal is connected to the second alternating-current terminal; and
a control means controlling the self arc-extinguishing elements to turn on/off them,
wherein the control means repeatedly switches on/off either a pair of the second and third self-extinguishing elements or a pair of the first and fourth self-extinguishing elements, which corresponds to the positive/negative voltage output from the alternating-current power, at a frequency equal to or higher than the frequency of the output voltage of the alternating-current power source, and keeps the other pair being off.

6. The power conversion device according to claim 5, further comprising a smoothing capacitor parallel-connected to the load between the first and second output terminals.

7. The power conversion device according to claim 5, further comprising a current detection means detecting the current flowing through the inductor, wherein:
the control means turns on/off the first through fourth self arc-extinguishing elements so that the current detected by the current detection means has a target waveform.

8. The power conversion device according to claim 5, wherein:
the control means turns on/off the first through fourth self arc-extinguishing elements so that the power factor of the power supplied from the alternating-current power source is nearly 1.

9. The power conversion device according to claim 5, further comprising a second inductor smoothing the rising edge of a current flowing through the magnetic energy recovery switch.

10. A power conversion device, comprising:
first, second, and third inductors having one end connected to each phase of a three-phase alternating-current power source;
a current direction switching means comprising first, second, and third input terminals and first, second, and third output terminals, in which the other end of the first inductor is connected to the first input terminal, the other end of the second inductor is connected to the second input terminal, and the other end of the third inductor is connected to the third input terminal, and a load is connected between the first and second output terminals for rectifying a three-phase alternating current entered from the first, second, and third input terminals to a direct current and outputting it from between the first and second output terminals;
a magnetic energy recovery switch comprising first, second, and third alternating-current terminals, first and second direct-current terminals, first through sixth diodes, first through sixth self arc-extinguishing elements, and a capacitor, in which the anode of the first diode and the cathode of the second diode are connected to the first alternating-current terminal, the anode of the third diode and the cathode of the fourth diode are connected to the second alternating-current terminal, the anode of the fifth diode and the cathode of the sixth diode are connected to the third alternating-current terminal, the cathodes of the first, third, and fifth diodes and one electrode of the capacitor are connected to the first direct-current terminal, the anodes of the second, fourth, and sixth diodes and the other electrode of the capacitor are connected to the second direct-current terminal, the first, second, third, fourth, fifth, and sixth self arc-extinguishing elements are parallel-connected to the first, second, third, fourth, fifth, and sixth diodes, respectively, the first input terminal is connected to the first alternating-current terminal, the second input terminal is connected to the second alternating-current terminal, and the third input terminal is connected to the third alternating-current terminal; and
a control means controlling the self arc-extinguishing elements to turn on/off them,
wherein the control means repeatedly switches the first self arc-distinguishing element at a frequency equal to or higher than the frequency of the output voltage of the alternating-current power source and keeps the second self arc-distinguishing element being off when the first phase output of the three-phase alternating-current power source is positive, and repeatedly switches on/off the second self arc-distinguishing element at a frequency equal to or higher than the frequency of the output voltage of the alternating-current power source and keeps the first self arc-distinguishing element being off when the first phase output is negative, repeatedly switches the third self arc-distinguishing element at a frequency equal to or higher than the frequency of the output voltage of the alternating-current power source and keeps the fourth self arc-distinguishing element being off when the second phase output is positive, and repeatedly switches on/off the fourth self arc-distinguishing element at a frequency equal to or higher than the frequency of the output voltage of the alternating-current power source and keeps the third self arc-distinguishing element being off when the second phase output is negative, and repeatedly switches the fifth self arc-distinguishing element at a frequency equal to or higher than the frequency of the output voltage of the alternating-current power source and keeps the sixth self arc-distinguishing element being off when the third phase output is positive, and repeatedly switches on/off the sixth self arc-distinguishing element at a frequency equal to or higher than the frequency of the output voltage of the alternating-current power source and keeps the fifth self arc-distinguishing element being off when the third phase output is negative.

11. The power conversion device according to claim 10, wherein:
the current direction switching means is a diode bridge.

12. The power conversion device according to claim 10, further comprising a second inductor smoothing the rising edge of a current flowing through the magnetic energy recovery switch.
